(19) United States
(12) Patent Application Publication
(10) Pub. No.: US 2025/0076592 A1
(43) Pub. Date: Mar. 6, 2025

(54) COMMUNICATION DEVICE AND COMMUNICATION SYSTEM

(71) Applicant: NEC Corporation, Tokyo (JP)

(72) Inventors: Masaki Aizono, Tokyo (JP); Atsushi Kamoi, Tokyo (JP); Fujio Okumura, Kanagawa (JP)

(73) Assignee: NEC Corporation, Tokyo (JP)

(21) Appl. No.: 18/772,261

(22) Filed: Jul. 15, 2024

(30) Foreign Application Priority Data
Aug. 31, 2023 (JP) 2023-140697

(51) Int. Cl. G02B 6/42

(52) U.S. Cl. CPC G02B 6/4206; G02B 6/4214

(57) ABSTRACT

Provided is a communication device including a ball lens, a transceiver in which a light receiver having a light reception axis passing through a center of the ball lens and a light transmitter having a light transmission axis parallel to the light reception axis are integrated, and a rotation mechanism that rotatably supports the transceiver along a circular orbit in a horizontal plane and a vertical plane centered on the ball lens.

This application is based upon and claims the benefit of priority from Japanese Patent Application No. 2023-140697, filed on Aug. 31, 2023, the disclosure of which is incorporated herein in its entirety by reference.

### TECHNICAL FIELD

The present disclosure relates to a communication device and a communication system.

### BACKGROUND ART

In spatial optical communication using signal light (hereinafter, also referred to as a spatial optical signal) propagating in a space, stable communication with a communication target cannot be performed unless position adjustment of a light transmitter and a light receiver is accurately performed. However, it is difficult to accurately match the transmission direction and the reception direction of the spatial optical signal. If the transmission direction and the reception direction of the spatial optical signal can be accurately matched, spatial optical communication using the spatial optical signal can be easily established with an arbitrary communication target.

PTL 1 (WO 2018/128118 A) discloses an optical communication device that performs communication using laser light between spatially separated points. The optical communication device of PTL 1 includes an angle correction device, an emission optical axis correction device, and a light receiving angle detection device. The angle correction device corrects the orientation of the light receiving system. The light receiving angle detection device detects an angle error that cannot be corrected by the angle correction device. The light receiving angle detection device controls the emission optical axis correction device according to the detected error amount to correct the emission optical axis.

In the method of PTL 1, the emission optical axis is corrected according to the error amount of the angle error detected by the light receiving angle detection device. According to the method of PTL 1, in a case where the direction of the communication target is determined, the orientation of the light receiving system and the light transmission axis of the spatial optical signal used for communication with the communication target can be adjusted. However, in the method of PTL 1, unless the direction of the communication target is determined, the orientation of the light receiving system of the spatial optical signal cannot be matched with the light transmission axis. That is, according to the method of PTL 1, spatial optical communication using a spatial optical signal cannot be established with a communication target disposed in an arbitrary azimuth.

An object of the present disclosure is to provide a communication device and a communication system capable of establishing spatial optical communication using a spatial optical signal with a communication target disposed in an arbitrary azimuth.

### SUMMARY

A communication device according to an aspect of the present disclosure includes a ball lens, a transceiver in which a light receiver having a light reception axis passing through a center of the ball lens and a light transmitter having a light transmission axis parallel to the light reception axis are integrated, and a rotation mechanism that rotatably supports the transceiver along a circular orbit in a horizontal plane and a vertical plane centered on the ball lens.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a communication device in the present disclosure;

FIG. 2 is a conceptual diagram illustrating an example of a configuration of a communication device in the present disclosure;

FIG. 3 is a conceptual diagram illustrating an example of a configuration of a light receiver included in a communication device in the present disclosure;

FIG. 4 is a conceptual diagram illustrating an example of a configuration of a light receiver included in a communication device in the present disclosure;

FIG. 5 is a conceptual diagram illustrating an example of a configuration of a light receiver included in a communication device in the present disclosure;

FIG. 6 is a conceptual diagram illustrating an example of a configuration of a light receiver included in a communication device in the present disclosure;

FIG. 7 is a conceptual diagram illustrating an example of light condensation by a ball lens included in a communication device in the present disclosure;

FIG. 8 is a conceptual diagram illustrating an irradiation example of an optical signal with respect to a light receiver included in a communication device in the present disclosure;

FIG. 9 is a conceptual diagram illustrating an irradiation example of an optical signal with respect to a light receiver included in a communication device in the present disclosure;

FIG. 10 is a conceptual diagram illustrating an example of a configuration of a light transmitter included in a communication device in the present disclosure;

FIG. 11 is a conceptual diagram illustrating an example of a configuration of a light transmitter included in a communication device in the present disclosure;

FIG. 12 is a conceptual diagram illustrating an example of a configuration of a light transmitter included in a communication device in the present disclosure;

FIG. 13 is a conceptual diagram illustrating an example of a configuration of a light transmitter included in a communication device in the present disclosure;

FIG. 14 is a conceptual diagram illustrating an example of a configuration of a communication control unit included in a communication device in the present disclosure;

FIG. 15 is a conceptual diagram for explaining detection of an arrival direction of a spatial optical signal by a communication device in the present disclosure;

FIG. 16 is a conceptual diagram illustrating an example of a position change of a light receiver included in a communication device of the present disclosure;

FIG. 17 is a conceptual diagram illustrating an example of a configuration of a communication control unit included in a communication device in the present disclosure;

FIG. 18 is a conceptual diagram for explaining a movement example in a vertical plane of a transceiver included in a communication device in the present disclosure;

FIG. 19 is a conceptual diagram for explaining a movement example in a vertical plane of a transceiver included in a communication device in the present disclosure;

FIG. 20 is a conceptual diagram for explaining a movement example in a horizontal plane of a transceiver included in a communication device in the present disclosure;

FIG. 21 is a conceptual diagram for explaining a movement example in a horizontal plane of a transceiver included in a communication device in the present disclosure;

FIG. 22 is a conceptual diagram illustrating an example of a configuration of a communication device in the present disclosure;

FIG. 23 is a conceptual diagram for explaining a movement example in a vertical plane of a transceiver included in a communication device in the present disclosure;

FIG. 24 is a conceptual diagram for explaining a movement example in a horizontal plane of a transceiver included in a communication device in the present disclosure;

FIG. 25 is a conceptual diagram illustrating an example of a configuration of a communication device in the present disclosure;

FIG. 26 is a conceptual diagram illustrating an example of a configuration of a communication device in the present disclosure;

FIG. 27 is a conceptual diagram for explaining an example of transmission of a spatial optical signal by a transceiver included in a communication device in the present disclosure;

FIG. 28 is a conceptual diagram illustrating an example of a configuration of a communication device in the present disclosure;

FIG. 29 is a conceptual diagram illustrating an example of a configuration of a communication device in the present disclosure;

FIG. 30 is a conceptual diagram illustrating an example of a configuration of a communication device in the present disclosure;

FIG. 31 is a conceptual diagram illustrating a configuration example of a communication system in which a communication device in the present disclosure is disposed;

FIG. 32 is a conceptual diagram illustrating an example of a configuration of a communication device in the present disclosure; and

FIG. 33 is a block diagram illustrating an example of a hardware configuration that executes control and processing in the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the orientations of the arrows in the drawings are merely examples, and do not limit the orientations of light and signals. A line indicating a trajectory of light in the drawings is conceptual and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated, or the configuration is complicated.

### First Example Embodiment

First, a reception device according to a first example embodiment will be described with reference to the drawings. The communication device of the present example embodiment is used for optical spatial communication in which signal light (hereinafter, also referred to as a spatial optical signal) propagating in a space are transmitted and received. The communication device of the present example embodiment may be used for applications other than optical spatial communication as long as the transmission device transmits light propagating in a space. The drawings used in the description of the present example embodiment are conceptual and do not accurately depict an actual structure.

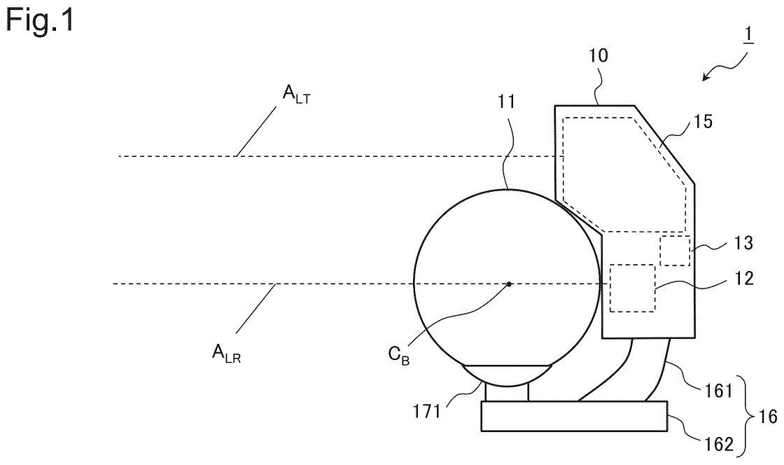

FIG. 1 is a conceptual diagram illustrating an example of a configuration of a communication device 1 according to the present disclosure. FIG. 1 is a conceptual diagram of the communication device 1 as viewed from a side. The communication device includes a transceiver 10, a ball lens 11, and a rotation mechanism 16. The rotation mechanism 16 includes a vertical rotation mechanism 161 and a horizontal rotation mechanism 162. Hereinafter, an outline of the transceiver 10, the ball lens 11, and the rotation mechanism 16 will be described, and then a light receiver 12, a communication control unit 13, and a light transmitter 15 included in the transceiver 10 will be individually described.

The ball lens 11 is disposed on a support unit 171 installed on the upper surface of the horizontal rotation mechanism 162. The ball lens 11 is a spherical lens. Hereinafter, the center of the ball lens 11 is referred to as C_{B}. The ball lens 11 is an optical element that collects a spatial optical signal arriving from the outside. The ball lens 11 has a spherical shape as viewed from any angle. The ball lens 11 condenses the incident spatial optical signal. Light (also referred to as a signal light) derived from the spatial optical signal condensed by the ball lens 11 is condensed toward the condensing region of the ball lens 11. Since the ball lens 11 has a spherical shape, the ball lens collects a spatial optical signal arriving from any direction. That is, the ball lens 11 exhibits similar light condensing performance for a spatial optical signal arriving from any direction. The light incident on the ball lens 11 is refracted when entering the inside of the ball lens 11. The light traveling inside the ball lens 11 is refracted again when being emitted to the outside of the ball lens 11. Most of the light emitted from the ball lens 11 is condensed toward the condensing region.

For example, the ball lens 11 can be made of a material such as glass, crystal, or resin. In the case of receiving a spatial optical signal in the visible region, the ball lens 11 can be achieved by a material that transmits/refracts light in the visible region. For example, the ball lens 11 can be achieved by optical glass such as crown glass or flint glass. For example, the ball lens 11 can be achieved by a crown glass such as Boron Kron (BK). For example, the ball lens 11 can be achieved by a flint glass such as Lanthanum Schwerflint (LaSF). For example, quartz glass can be applied to the ball lens 11. For example, a crystal such as sapphire can be applied to the ball lens 11. For example, a transparent resin such as acrylic can be applied to the ball lens 11.

In a case where the spatial optical signal is light in a near-infrared region (hereinafter, also referred to as near-infrared rays), a material that transmits near-infrared rays is used for the ball lens 11. For example, in a case of receiving a spatial optical signal in a near-infrared region of about 1.5 micrometers (μm), a material such as silicon can be applied to the ball lens 11 in addition to glass, crystal, resin, and the like. In a case where the spatial optical signal is light in an infrared region (hereinafter, also referred to as infrared rays), a material that transmits infrared rays is used for the ball lens 11. For example, in a case where the spatial optical signal is an infrared ray, silicon, germanium, or a chalcogenide material can be applied to the ball lens 11. The material of the ball lens 11 is not limited as long as light in the wavelength region of the spatial optical signal can be transmitted/refracted. The material of the ball lens 11 may be appropriately selected according to the required refractive index and use.

The transceiver 10 includes a light receiver 12, a communication control unit 13, and a light transmitter 15. The light receiver 12, the communication control unit 13, and the light transmitter 15 are stored inside a housing of the transceiver 10. In FIG. 1, an example of a region where the light receiver 12, the communication control unit 13, and the light transmitter 15 are disposed is indicated by a broken line. In FIG. 1, regions (broken lines) in which the light receiver 12, the communication control unit 13, and the light transmitter 15 are disposed schematically represent the positions thereof, and do not represent accurate positions. In the housing of the transceiver 10, windows are formed in front of the light receiving surface of the light receiver 12 and in front of the transmission surface of the light transmitter 15. For example, a window material formed of a material through which a spatial optical signal is transmitted is disposed in the window. For example, the window may be open.

The light receiver 12 is disposed in a condensing region including a condensing point of the ball lens 11. The condensing point of the ball lens 11 is not uniquely determined. Therefore, the light receiver 12 is disposed in the condensing region including the condensing point of the ball lens 11. In the example of FIG. 1, the light receiver 12 is disposed on the side of the ball lens 11. The light receiver 12 includes a plurality of direction detecting light receiving elements and a communication light receiving element. The communication light receiving element is disposed near the condensing point. The plurality of direction detecting light receiving elements are disposed closer to the ball lens 11 than the communication light receiving elements. When viewed from the ball lens, the plurality of direction detecting light receiving elements are disposed on concentric circles centered on the communication light receiving element. The light receiving surfaces of the direction detecting light receiving element and the communication light receiving element are disposed toward the ball lens 11. A perpendicular line (also referred to as a light reception axis A_{LR}) to the light receiving surface of the communication light receiving element passes through the center C_{B} of the ball lens 11. The plurality of direction detecting light receiving elements and the communication light receiving element output an electric signal relevant to the received optical signal to the communication control unit 13.

The communication control unit 13 (also referred to as the communication controller) acquires an electric signal derived from the optical signal received by the light receiver 12. The communication control unit 13 controls the rotation mechanism 16 and the light transmitter 15 according to the acquired electric signal. The communication control unit 13 detects the arrival direction of the spatial optical signal according to the electric signals derived from the plurality of direction detecting light receiving elements. The communication control unit 13 controls the rotation mechanism 16 according to the arrival direction of the spatial optical signal to move the transceiver 10. The communication control unit 13 controls the light transmitter 15 to transmit a scanning spatial optical signal for establishing communication with the communication target. The communication control unit 13 transmits and receives the spatial optical signals for scanning to and from the communication target, and adjusts the transmission/reception direction of the spatial optical signals. The communication control unit 13 moves the transceiver 10 to a position where the intensities of the optical signals received by the plurality of direction detecting light receiving elements are uniform. The communication control unit 13 moves the transceiver 10 to a position where the intensity of the optical signal received by the communication light receiving element is maximized, and establishes communication with the communication target. When communication with the communication target is established, the communication control unit 13 transmits a spatial optical signal for communication to the communication target.

The light transmitter 15 transmits the spatial optical signal under the control of the communication control unit 13. At the stage of establishing communication with the communication target, the light transmitter 15 transmits a spatial optical signal for scanning. When communication with the communication target is established, the light transmitter 15 transmits a spatial optical signal for communication. A light transmission axis A_{LT} of the spatial optical signal transmitted from the light transmitter 15 passes above the ball lens 11. A light transmission axis A_{LT} of the spatial optical signal transmitted from the light transmitter 15 is parallel to the light reception axis A_{LR} of the communication light receiving element of the light receiver 12. The light transmission axis A_{LT} and the light reception axis A_{LR} are always parallel. Therefore, by controlling the rotation mechanism 16 so as to direct the light receiving surface of the light receiver 12 toward the communication target, the transmission direction of the spatial optical signal can be directed toward the communication target. In the present example embodiment, a configuration in which the light transmitter 15 includes a phase modulation-type spatial light modulator will be described as an example. In the phase modulation-type spatial light modulator, the transmission direction of the spatial optical signal can be adjusted by the pattern (phase image) set in the modulation part. Therefore, even if the light transmission axis A_{LT} and the light reception axis A_{LR} with respect to the same communication target are not completely parallel, transmission and reception of the spatial optical signal can be optimized.

The rotation mechanism 16 includes a vertical rotation mechanism 161 and a horizontal rotation mechanism 162. Hereinafter, the vertical plane is a plane perpendicular to the horizontal plane. In a case where the communication device 1 is disposed on a horizontal plane, the vertical plane coincides with a circular plane. In a case where the communication device 1 is disposed obliquely with respect to the horizontal plane, the vertical plane is perpendicular to the bottom surface of the communication device 1.

The vertical rotation mechanism 161 moves the transceiver 10 in a vertical plane. The vertical rotation mechanism 161 moves the transceiver 10 on an arc centered on the center C_{B} of the ball lens 11. In the movement in the vertical plane, the light receiving surface of the light receiver 12 is directed toward the center C_{B} of the ball lens 11. The light reception axis A_{LR} of the communication light receiving element of the light receiver 12 always passes through the center C_{B} of the ball lens 11.

The horizontal rotation mechanism 162 moves the transceiver 10 in a horizontal plane. The vertical rotation mechanism 161 moves the transceiver 10 on an arc centered on the center C_{B} of the ball lens 11. In the movement in the horizontal plane, the light receiving surface of the light receiver 12 is directed to the center C_{B} of the ball lens 11. The light reception axis A_{LR} of the communication light receiving element of the light receiver 12 always passes through the center C_{B} of the ball lens 11.

The vertical rotation mechanism 161 and the horizontal rotation mechanism 162 include a drive device such as a small motor such as a micro stepping motor. The communication control unit 13 drives and controls the drive devices included in the vertical rotation mechanism 161 and the horizontal rotation mechanism 162 to move the transceiver 10 in the vertical plane and the horizontal plane.

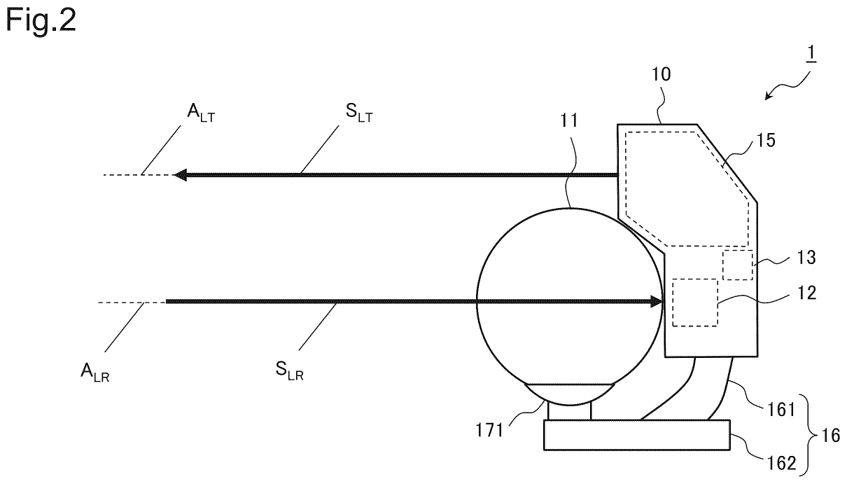

FIG. 2 is a conceptual diagram for explaining an example of transmission and reception of a spatial optical signal in the transceiver 10. The light receiver 12 receives a spatial optical signal S_{LR} arriving along the light reception axis A_{LR}. The light transmitter 15 transmits a spatial optical signal S_{LT} along the light transmission axis A_{LT}. The light reception axis A_{LR} and the light transmission axis A_{LT} are always parallel. That is, the reception direction of the spatial optical signal S_{LR} and the transmission direction of the spatial optical signal S_{LT} are always parallel.

### [Receiver]

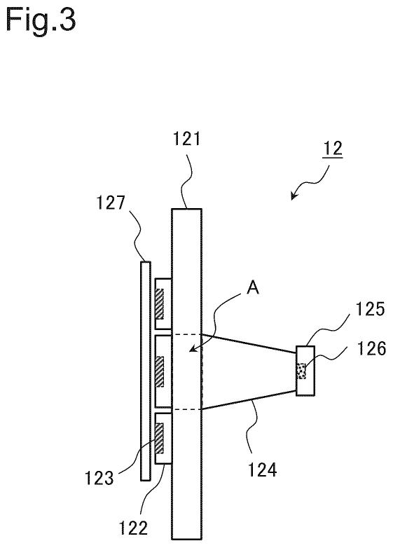

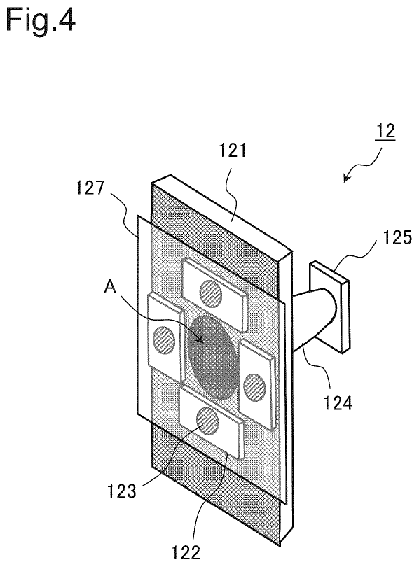

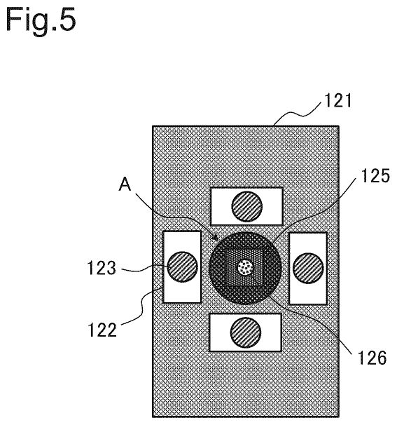

FIGS. 3 to 5 are conceptual diagrams illustrating an example of a configuration of the light receiver 12. FIG. 3 is a side view of the light receiver 12 as viewed from a side. FIG. 4 is a perspective view of the light receiving surface of the light receiver 12 as viewed obliquely from above. FIG. 5 is a front view of the light receiver 12 as viewed from the ball lens 11. The light receiver 12 includes a substrate 121, a direction detecting light receiving element 122, a light guide tube 124, a communication light receiving element 125, and a wavelength filter 127. The light receiver 12 includes a plurality of direction detecting light receiving elements 122. In the example of FIGS. 3 to 5, the light receiver 12 includes four direction detecting light receiving elements 122. The number of the direction detecting light receiving elements 122 is not limited to four.

The substrate 121 is a substrate used for a printed circuit board. A through hole A is formed in the substrate 121. The opening diameter of the through hole A is formed in accordance with the size of a first opening end (the opening end on the left side in FIG. 2) of the light guide tube 124. On a first surface (the surface on the left side in FIG. 2) of the substrate 121, a plurality of direction detecting light receiving elements 122 are disposed around the through hole A. In the example of FIGS. 2 to 4, four direction detecting light receiving elements 122 are disposed around the through hole A.

The plurality of direction detecting light receiving elements 122 are disposed on the first surface (the surface on the left side in FIG. 2) of the substrate 121. The plurality of direction detecting light receiving elements 122 are disposed in a point-symmetric positional relationship with respect to the center of the through hole A of the substrate 121. A light receiving part 123 of the direction detecting light receiving element 122 is directed to the ball lens 11 via the wavelength filter 127. The direction detecting light receiving element 122 has sensitivity to light in the wavelength band of the spatial optical signal to be communicated. For example, the direction detecting light receiving element 122 is implemented by a photodiode having sensitivity to infrared rays. For example, the direction detecting light receiving element 122 is implemented by an indium gallium arsenide InGaAs-based photodiode. For example, the communication light receiving element 125 is implemented by an InGaAs-based photodiode. Since the direction detecting light receiving element 122 only needs to be able to detect the spatial optical signal, the sensitivity may be smaller than that of the communication light receiving element 125. The spatial optical signal received by the direction detecting light receiving element 122 is converted into an electric signal. The converted electric signal is output to the communication control unit 13. In a case where the communication control unit 13 includes an integrator (not illustrated), the converted electric signal is supplied to the integrator included in the communication control unit 13. The electric signal supplied to the integrator is integrated to a level that can be detected by the communication control unit 13.

The light guide tube 124 is a tubular member having a first opening end and a second opening end. The first opening end (opening end on the left side in FIG. 2) is formed in accordance with the size of the opening diameter of the through hole A. The second opening end (the opening end on the right side in FIG. 2) has a smaller opening diameter than the first opening end. The opening diameter of the second opening end is formed in accordance with a light receiving part 126 of the communication light receiving element 125. The opening diameter of the second opening end is larger than the outer periphery of the light receiving unit 126 of the communication light receiving element 125. A material and a shape of the light guide tube 124 are not particularly limited. For example, a reflecting surface on which an optical signal is reflected is formed on the inner surface of the light guide tube 124. For example, a light absorbing material for reducing irregular reflection of an optical signal may be disposed on the inner surface of the light guide tube 124.

The communication light receiving element 125 is disposed at the second opening end (the opening end on the right side in FIG. 2) of the light guide tube 124. The light receiving part 126 of the communication light receiving element 125 is directed to the ball lens 11 via the wavelength filter 127. The communication light receiving element 125 has sensitivity to light in a wavelength band of a spatial optical signal to be communicated. For example, the communication light receiving element 125 is implemented by a photodiode having sensitivity to infrared rays. For example, in the communication light receiving element 125, a spatial optical signal received by the communication light receiving element 125 implemented by an indium gallium arsenide (InGaAs)-based photodiode is converted into an electric signal. The converted electric signal is output to the communication control unit 13.

The wavelength filter 127 is a wavelength filter through which light in a wavelength band of a spatial optical signal to be received passes. The wavelength filter 127 passes light in a wavelength band of a spatial optical signal to be received by the direction detecting light receiving element 122 and the communication light receiving element 125. The wavelength filter 127 blocks light that is not a reception target. The main purpose of the wavelength filter 127 is to reduce the influence of sunlight. In an environment less affected by sunlight or external light, the wavelength filter 127 may be omitted.

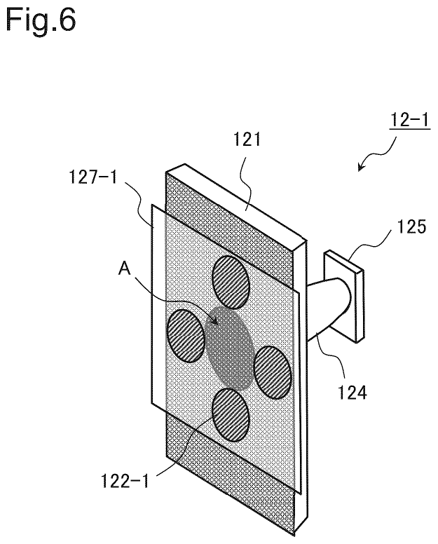

FIG. 6 is a conceptual diagram illustrating another example (light receiver 12-1) of the light receiver 12. FIG. 6 is a view of the light receiving surface of the light receiver 12-1 as viewed from an obliquely upper side. In the light receiver 12-1, instead of the direction detecting light receiving element 122, a direction detecting light receiving element 122-1 is disposed. For example, a silicon-based or germanium-based photodiode can be applied to the direction detecting light receiving element 122-1. Compared with the InGaAs photodiode, the silicon-based or germanium-based photodiode can set the light receiving area to be large at lower cost. In the light receiver 12-1, a wavelength filter 127-1 that selectively passes light in a wavelength band in which a silicon-based or germanium-based photodiode and an InGaAs photodiode have sensitivity is disposed. According to the configuration of FIG. 6, the light receiving area of the direction detecting light receiving element 122-1 can be increased.

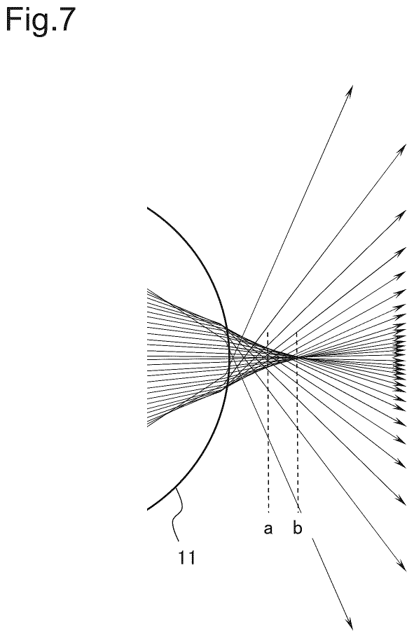

FIG. 7 is a conceptual diagram for explaining an example of a trajectory of light condensed by the ball lens 11. FIG. 7 is a conceptual diagram of a part of the ball lens 11 as viewed from a side. The intensity of light in the condensing region of the ball lens 11 changes according to the position from the ball lens 11. Compared with a position a, a position b (also referred to as a condensing point) has a larger light flux density. Therefore, the intensity of the received light is larger at the position b. The light receiving part 126 of the communication light receiving element 125 is disposed near the position b. Therefore, the light receiving efficiency of the signal light by the communication light receiving element 125 is improved. In other words, the light receiving part 126 of the communication light receiving element 125 is disposed in accordance with the position b. On the other hand, the direction detecting light receiving element 122 is disposed at a position closer to the ball lens 11 than the communication light receiving element 125.

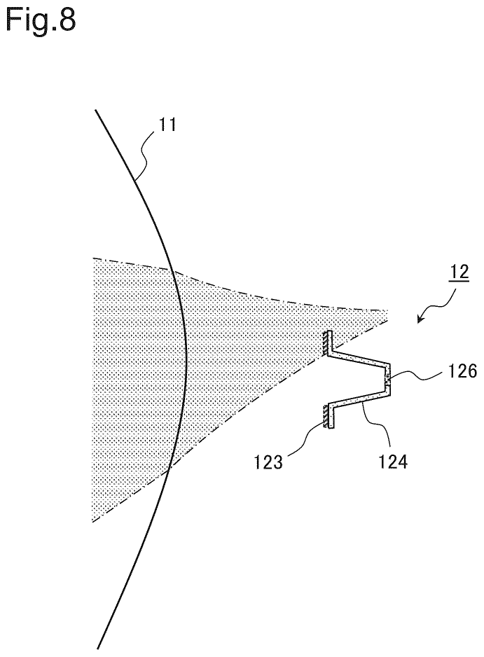

FIG. 8 is a conceptual diagram illustrating an example of a state in which the signal light condensed by the ball lens 11 is incident on the light receiver 12. FIG. 8 illustrates a part of the light receiver 12. FIG. 8 is a cross-sectional view of the light receiver 12 as viewed from a side. In the example of FIG. 8, the signal light condensed by the ball lens 11 is not emitted to the light receiving part 126 of the communication light receiving element 125, but is emitted to the light receiving part 123 of some of the direction detecting light receiving elements 122. In the case of the example of FIG. 8, it is necessary to change the position of the light receiver 12. The communication control unit 13 changes the position of the transceiver 10 according to the position of the direction detecting light receiving element 122 that has received the signal light. In the case of the example of FIG. 8, the communication control unit 13 moves the transceiver 10 upward.

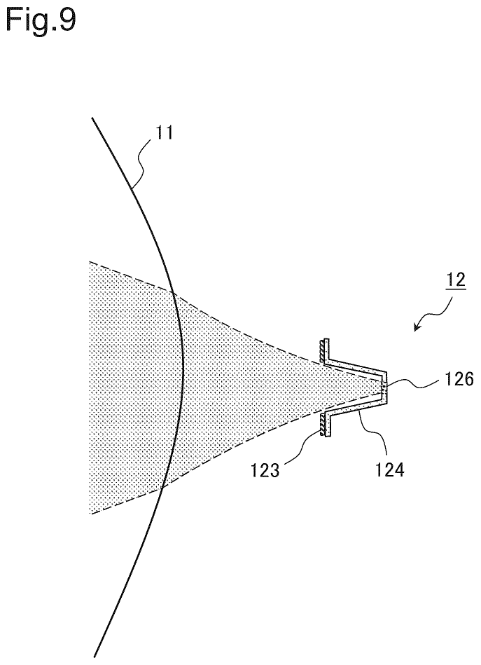

FIG. 9 is a conceptual diagram illustrating an example of a state in which the signal light condensed by the ball lens 11 is incident on the light receiver 12. FIG. 9 illustrates a part of the light receiver 12. FIG. 9 is a cross-sectional view of the light receiver 12 as viewed from a side. In the example of FIG. 9, the signal light condensed by the ball lens 11 is emitted to the light receiving part 126 of the communication light receiving element 125. In the case of the example of FIG. 9, the electric signal derived from the signal light received by the communication light receiving element 125 is processed by the communication control unit 13.

### [Light Transmitter]

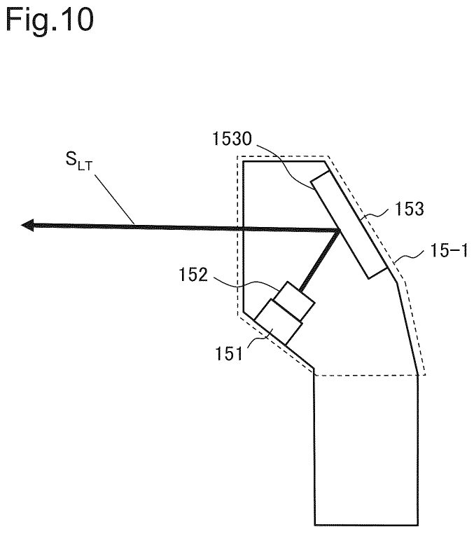

FIG. 10 is a conceptual diagram illustrating an example (light transmitter 15-1) of the light transmitter 15. FIG. 10 illustrates an example in which light in the Fraunhofer region is used. In FIG. 10, a region where the light transmitter 15-1 is disposed is indicated by a broken line frame. The light transmitter 15-1 includes a light source 151, a collimator 152, and a spatial light modulator 153. FIG. 10 conceptually illustrates a positional relationship among the light source 151, the collimator 152, and the spatial light modulator 153. FIG. 10 does not limit the positional relationship among the light source 151, the collimator 152, and the spatial light modulator 153.

The light source 151 is disposed inside the housing of the transceiver 10 with the emission surface facing obliquely upward. An emission surface of the light source 151 is directed to a modulation part 1530 of the spatial light modulator 153 disposed above. The light source 151 includes at least one emitter (not illustrated). The at least one emitter emits the emitted light according to the control of the communication control unit 13. The light emitted from the emitter is converted into parallel light (illumination light) by the collimator 152.

For example, the light source 151 may include a plurality of emitters that emit the light of the same wavelength band. For example, the light source 151 is implemented by a laser array in which a plurality of light emitters are arranged in an array. For example, a laser array has a plurality of emitters arranged in 4 rows×2 columns. For example, the light source 151 may be a combination of a plurality of emitters that emit illumination light of the same wavelength band and an emitter that emits illumination light of a wavelength band different from those of the plurality of emitters. For example, the light source 151 may have a configuration in which an emitter that emits laser light in a wavelength band used for communication with a communication target and an emitter that emits laser light in a wavelength band different from the wavelength band of the laser light are combined. For example, one of the plurality of light emitters constituting the laser array is a search emitter, and the others are communication emitters. For example, the search emitter emits light in a wavelength band of 850 nm, and the communication emitter emits light in a wavelength band of 1550 nm. If the laser array is configured as described above, search is performed using the search emitter (850 nm), and when the search is completed, the laser array can be switched to communication using the communication emitter (1550 nm). In this case, a silicon-based photodiode can be applied to the direction detecting light receiving element 122. On the other hand, a germanium-based photodiode can be applied to the direction detecting light receiving element 122. A wavelength filter that selectively allows light in a wavelength band of 850 nm to pass is disposed at a preceding stage of the direction detecting light receiving element 122. A wavelength filter that selectively allows light in a wavelength band of 1550 nm to pass is disposed at a preceding stage of the communication light receiving element 125. As compared with germanium-based photodiodes, silicon-based photodiodes are less expensive and larger in size. Even if different wavelength filters are applied to the direction detecting light receiving element 122 and the communication light receiving element 125, if a silicon-based photodiode can be applied to the direction detecting light receiving element 122, accuracy of direction detection is improved. The search emitter and the communication emitter may emit light of the same wavelength band. In this case, a single wavelength filter can be disposed at a preceding stage of the direction detecting light receiving element 122 and the communication light receiving element 125.

For example, an emitter included in the light source 151 emits laser light of a predetermined wavelength band. The wavelength of the laser light emitted from the emitter is not particularly limited, and may be selected according to the application. For example, the emitter emits the laser light in visible or infrared wavelength bands. For example, in the case of near infrared rays of 800 to 1000 nm, the laser class can be given compared to the visible light, and thus the sensitivity can be improved more than the visible light. For example, a laser light source having a higher output than the near infrared rays of 800 to 1000 nm for infrared rays can be used in a wavelength band of 1.55 micrometers (μm). As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. For example, the emitter may be implemented by a surface emitting element such as a photonic crystal surface emitting laser (PCSEL).

The collimator 152 is disposed on the emission surface of the light source 151. The collimator 152 converts the light emitted from the light source 151 into parallel light. The parallel light (illumination light) converted by the collimator 152 is emitted to the modulation part 1530 of the spatial light modulator 153. For example, each of the plurality of emitters is associated with at least one of the plurality of modulation regions set in the modulation part 1530 of the spatial light modulator 153. The illumination light derived from the light emitted from each of the plurality of emitters travels toward the associated modulation region.

The spatial light modulator 153 is a phase modulation-type spatial light modulator. The spatial light modulator 153 includes the modulation part 1530. The spatial light modulator 153 is disposed obliquely above the light source 151. The modulation part 1530 of the spatial light modulator 153 is directed to the emission surface of the light source 151. In the example of FIG. 10, the spatial light modulator 153 is disposed inside the transceiver 10. The spatial light modulator 153 is disposed at a position where reflected light (modulation light) of the illumination light with which the modulation part 1530 is irradiated is transmitted as the spatial optical signal S_{LT}. The illumination light applied to the modulation part 1530 of the spatial light modulator 153 is modulated according to the pattern (phase image) set in the modulation part 1530. The modulation light modulated by the modulation part 1530 is transmitted as a spatial optical signal. The traveling direction of the spatial optical signal (modulation light) is adjusted according to the set pattern (phase image) of the modulation part 1530.

For example, the spatial light modulator 153 is achieved by a spatial light modulator using ferroelectric liquid crystal, homogeneous liquid crystal, vertical alignment liquid crystal, or the like. For example, the spatial light modulator 153 can be achieved by liquid crystal on silicon (LCOS). The spatial light modulator 153 may be achieved by a micro electro mechanical system (MEMS). In the spatial light modulator 153 of the phase modulation type, the energy can be concentrated on the portion of the image by operating to sequentially switch the portion used for transmission of the spatial optical signal S_{LT}. Therefore, in the case of using the spatial light modulator 153 of the phase modulation type, if the output of the emitter included in the light source 151 is the same, the image can be displayed brighter than other methods.

At least one modulation region is set in the modulation part 1530 of the spatial light modulator 153. The number of modulation regions set in the modulation part 1530 is set in accordance with the number of emitters included in the light source 151. Each of the plurality of modulation regions is associated with one of the plurality of emitters included in the light source 151. Each of the plurality of modulation regions is irradiated with the illumination light derived from the laser light emitted from the associated emitter. However, the correspondence relationship between the modulation region and the emitter is not particularly limited as long as the illumination light derived from the laser light emitted from the emitter is incident on the modulation surface of the modulation region. The number of modulation regions set in the modulation part 1530 may be different from the number of light emitters included in the light source 151.

The modulation region is divided into a plurality of regions (also referred to as tiling). A phase image is assigned to each of the plurality of tiles. Each of the plurality of tiles includes a plurality of pixels. A phase image relevant to a projected image is set to each of the plurality of tiles. A phase image is tiled to each of the plurality of tiles allocated to the modulation region. For example, a phase image generated in advance is set in each of the plurality of tiles. When the modulation region is irradiated with the illumination light in a state where the phase image is set in the plurality of tiles, the modulation light is emitted to form an image relevant to the phase image of each tile. As the number of tiles set in the modulation region increases, a clear image can be displayed. However, when the number of pixels of each tile decreases, the resolution decreases. Therefore, the size and number of tiles set in the modulation region are set according to the application.

A pattern (also referred to as a phase image) relevant to the image displayed by the spatial optical signal S_{LT} is set in each of the plurality of modulation regions under the control of the communication control device. A pattern (phase image) is set in each of the plurality of modulation regions. The illumination light with which each of the plurality of modulation regions is irradiated is modulated according to a pattern (phase image) set in the modulation region. The modulation light modulated in each of the plurality of modulation regions is transmitted as the spatial optical signal S_{LT}.

For example, a shield (not illustrated) may be disposed at a subsequent stage of the spatial light modulator 153. The shield is a frame that shields unnecessary light components included in the modulation light and defines an outer edge of a display region of the projection light. For example, the shield is an aperture. In such an aperture, a slit-shaped opening is formed in a portion through which light (desired light) for forming a desired image passes. The desired light is first-order diffracted light. The shield passes the desired light and blocks unwanted light components. For example, the shield blocks a ghost image including 0th-order light included in the modulation light, unnecessary first-order light appearing at a point symmetric position with respect to desired light with the 0th-order light as a center, and second or higher-order light. Details of the shield will not be described. For example, a projection lens (not illustrated) may be disposed at a subsequent stage of the spatial light modulator 153.

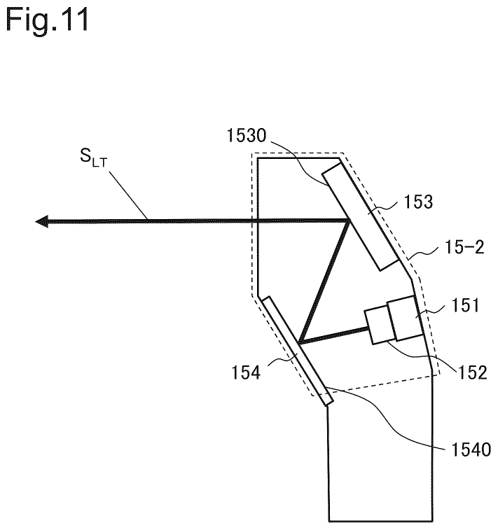

FIG. 11 is a conceptual diagram illustrating an example (light transmitter 15-2) of the light transmitter 15. The light transmitter 15-2 (FIG. 11) has a configuration in which a flat mirror 154 is added to the light transmitter 15-1 (FIG. 10). In the light transmitter 15-2 (FIG. 11), a configuration for forming an image in the Fraunhofer region by folding back using the flat mirror 154 is achieved. In FIG. 11, a region where the light transmitter 15-2 is disposed is indicated by a broken line frame. The light transmitter 15-2 includes a light source 151, a collimator 152, a spatial light modulator 153, and a flat mirror 154. FIG. 11 conceptually illustrates a positional relationship among the light source 151, the collimator 152, the spatial light modulator 153, and the flat mirror 154. FIG. 11 does not limit the positional relationship among the light source 151, the collimator 152, the spatial light modulator 153, and the flat mirror 154. The light source 151, the collimator 152, and the spatial light modulator 153 of the light transmitter 15-2 (FIG. 11) are similar to those of the light transmitter 15-1 (FIG. 10), and thus, detailed description thereof is omitted.

The light source 151 is disposed inside the housing of the transceiver 10 with the emission surface facing obliquely downward. The emission surface of the light source 151 is directed to a reflecting surface 1540 of the flat mirror 154 disposed obliquely downward. The light source 151 includes at least one emitter (not illustrated). The at least one emitter emits the emitted light according to the control of the communication control unit 13. The light emitted from the emitter is converted into parallel light (illumination light) by the collimator 152. As compared with the configuration of FIG. 10, the light source 151 is disposed at a position farther from the ball lens 11 in the configuration of FIG. 11. Therefore, the heat generated from the light source 151 is more easily released to the outside in the configuration of FIG. 11 than in the configuration of FIG. 10.

The collimator 152 is disposed on the emission surface of the light source 151. The collimator 152 converts the light emitted from the light source 151 into parallel light. The parallel light (illumination light) converted by the collimator 152 is emitted to the reflecting surface 1540 of the flat mirror 154.

The flat mirror 154 is disposed obliquely below the light source 151 and the spatial light modulator 153. The flat mirror 154 has the reflecting surface 1540. The reflecting surface 1540 is directed toward the light source 151 and the spatial light modulator 153. The reflecting surface 1540 is irradiated with illumination light. The reflecting surface 1540 reflects the emitted illumination light toward the modulation part 1530 of the spatial light modulator 153.

The spatial light modulator 153 is disposed obliquely above the flat mirror 154. In the example of FIG. 11, the spatial light modulator 153 is disposed inside the transceiver 10. The modulation part 1530 of the spatial light modulator 153 is directed to the reflecting surface 1540 of the flat mirror 154. The spatial light modulator 153 is disposed at a position where the reflected light (modulation light) reflected by the reflecting surface 1540 of the flat mirror 154 is transmitted as the spatial optical signal S_{LT}. The illumination light applied to the modulation part 1530 of the spatial light modulator 153 is modulated according to the pattern (phase image) set in the modulation part 1530. The modulation light modulated by the modulation part 1530 is transmitted as a spatial optical signal. The traveling direction of the spatial optical signal (modulation light) is adjusted according to the set pattern (phase image) of the modulation part 1530.

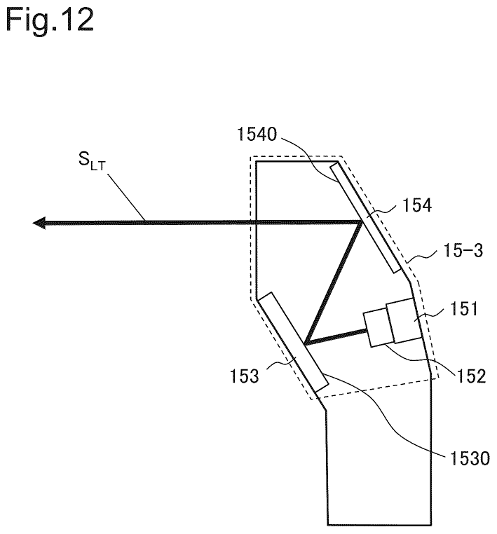

FIG. 12 is a conceptual diagram illustrating an example (light transmitter 15-3) of the light transmitter 15. The light transmitter 15-3 (FIG. 12) has a configuration in which the positions of the spatial light modulator 153 and the flat mirror 154 are interchanged in the configuration of the light transmitter 15-2 (FIG. 11). In the light transmitter 15-3 (FIG. 12), the configuration of the Fraunhofer is implemented by folding back using the flat mirror 154. In FIG. 12, a region where the light transmitter 15-3 is disposed is indicated by a broken line frame. The light transmitter 15-3 includes a light source 151, a collimator 152, a spatial light modulator 153, and a flat mirror 154. FIG. 12 conceptually illustrates a positional relationship among the light source 151, the collimator 152, the spatial light modulator 153, and the flat mirror 154. FIG. 12 does not limit the positional relationship among the light source 151, the collimator 152, the spatial light modulator 153, and the flat mirror 154. The light source 151, the collimator 152, and the spatial light modulator 153 of the light transmitter 15-3 (FIG. 12) are similar to those of the light transmitters 15-1 and 15-2 (FIGS. 10 and 11), and thus, detailed description thereof is omitted.

The light source 151 is disposed inside the housing of the transceiver 10 with the emission surface facing obliquely downward. An emission surface of the light source 151 is directed to a modulation part 1530 of the spatial light modulator 153 disposed obliquely below. The light source 151 includes at least one emitter (not illustrated). The at least one emitter emits the emitted light according to the control of the communication control unit 13. The light emitted from the emitter is converted into parallel light (illumination light) by the collimator 152.

The collimator 152 is disposed on the emission surface of the light source 151. The collimator 152 converts the light emitted from the light source 151 into parallel light. The parallel light (illumination light) converted by the collimator 152 is emitted to the modulation part 1530 of the spatial light modulator 153.

The spatial light modulator 153 is disposed obliquely below the light source 151 and the flat mirror 154. In the example of FIG. 12, the spatial light modulator 153 is disposed inside the transceiver 10. The modulation part 1530 of the spatial light modulator 153 is directed to the reflecting surface 1540 of the flat mirror 154. The spatial light modulator 153 is disposed at a position irradiated with the illumination light having passed through the collimator 152. The illumination light applied to the modulation part 1530 of the spatial light modulator 153 is modulated according to the pattern (phase image) set in the modulation part 1530. The modulation light modulated by the modulation part 1530 of the spatial light modulator 153 travels toward the reflecting surface 1540 of the flat mirror 154.

The flat mirror 154 is disposed obliquely above the spatial light modulator 153. The flat mirror 154 has the reflecting surface 1540. The reflecting surface 1540 is directed to the spatial light modulator 153. The reflecting surface 1540 is irradiated with the modulation light modulated by the modulation part 1530 of the spatial light modulator 153. The reflecting surface 1540 reflects the emitted modulation light. The modulation light modulated by the reflecting surface 1540 is transmitted as a spatial optical signal. The traveling direction of the spatial optical signal (modulation light) is adjusted according to the set pattern (phase image) of the modulation part 1530.

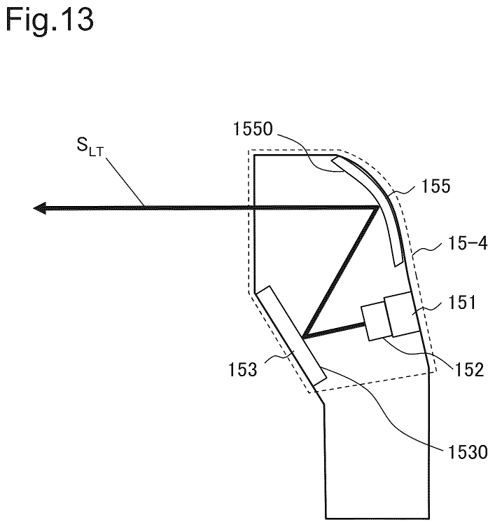

FIG. 13 is a conceptual diagram illustrating an example (light transmitter 15-4) of the light transmitter 15. The light transmitter 15-4 (FIG. 13) has a configuration in which the flat mirror 154 is replaced with a concave mirror 155 in the configuration of the light transmitter 15-3 (FIG. 12). In FIG. 13, a region where the light transmitter 15-4 is disposed is indicated by a broken line frame. The light transmitter 15-4 includes a light source 151, a collimator 152, a spatial light modulator 153, and a concave mirror 155. FIG. 13 conceptually illustrates a positional relationship among the light source 151, the collimator 152, the spatial light modulator 153, and the concave mirror 155. FIG. 13 does not limit the positional relationship among the light source 151, the collimator 152, the spatial light modulator 153, and the concave mirror 155. The light source 151, the collimator 152, and the spatial light modulator 153 of the light transmitter 15-2 (FIG. 11) are similar to those of the light transmitters 15-1 to 15-3 (FIGS. 10 to 12), and thus, detailed description thereof is omitted.

The light source 151 is disposed inside the housing of the transceiver 10 with the emission surface facing obliquely downward. An emission surface of the light source 151 is directed to a modulation part 1530 of the spatial light modulator 153 disposed obliquely below. The light source 151 includes at least one emitter (not illustrated). The at least one emitter emits the emitted light according to the control of the communication control unit 13. The light emitted from the emitter is converted into parallel light (illumination light) by the collimator 152.

The collimator 152 is disposed on the emission surface of the light source 151. The collimator 152 converts the light emitted from the light source 151 into parallel light. The parallel light (illumination light) converted by the collimator 152 is emitted to the modulation part 1530 of the spatial light modulator 153.

The spatial light modulator 153 is disposed obliquely below the light source 151 and the concave mirror 155. In the example of FIG. 13, the spatial light modulator 153 is disposed inside the transceiver 10. The modulation part 1530 of the spatial light modulator 153 is directed to the reflecting surface 1540 of the concave mirror 155. The spatial light modulator 153 is disposed at a position irradiated with the illumination light having passed through the collimator 152. The illumination light applied to the modulation part 1530 of the spatial light modulator 153 is modulated according to the pattern (phase image) set in the modulation part 1530. The modulation light modulated by the modulation part 1530 of the spatial light modulator 153 travels toward a reflecting surface 1550 of the concave mirror 155.

The concave mirror 155 is disposed obliquely above the spatial light modulator 153. The concave mirror 155 has a concave reflecting surface 1550. The reflecting surface 1550 is directed to the spatial light modulator 153. The reflecting surface 1550 is irradiated with the modulation light modulated by the modulation part 1530 of the spatial light modulator 153. The reflecting surface 1550 reflects the emitted modulation light. The modulation light modulated by the reflecting surface 1550 is transmitted as a spatial optical signal. The traveling direction of the spatial optical signal (modulation light) is adjusted according to the set pattern (phase image) of the modulation part 1530. The traveling direction of the spatial optical signal (modulation light) is adjusted according to the irradiation position on the reflecting surface 1550.

The beam diameter of the spatial optical signal S_{LT} is narrower in the case of using the concave mirror 155 than in the case of using the flat mirror 154. Therefore, if the distance from the communication device 1 is the same, the intensity of the spatial optical signal S_{LT} is larger in the case of using the concave mirror 155 than in the case of using the flat mirror 154. In other words, the spatial optical signal S_{LT} is less likely to be attenuated in the case of using the concave mirror 155 than in the case of using the flat mirror 154. Therefore, the communication distance of the light transmitter 15-4 (FIG. 13) can be extended more than that of the light transmitters 15-1 to 15-3 (FIGS. 10 to 12).

### [Communication Control Unit]

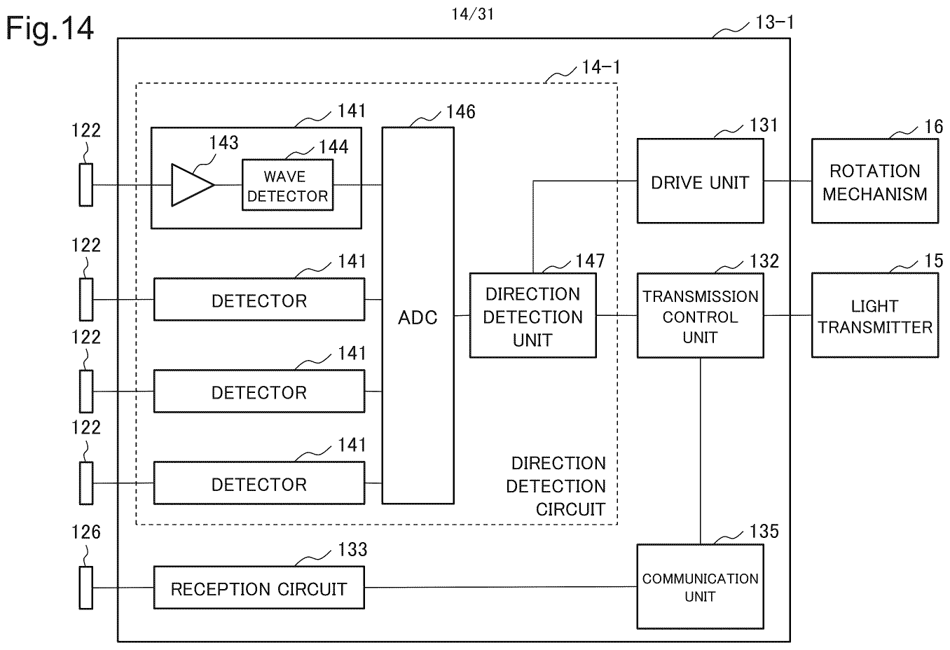

FIG. 14 is a conceptual diagram illustrating an example (communication control unit 13-1) of the configuration of the communication control unit 13. The communication control unit 13 includes a direction detection circuit 14-1, a drive unit 131, a transmission control unit 132, a reception circuit 133, and a communication unit 135.

The direction detection circuit 14-1 includes a plurality of detectors 141, an analog-to-digital conversion circuit (ADC 146), and a direction detection unit 147 (analog-to-digital converter (ADC)). Each of the plurality of detectors 141 is connected to each of the plurality of direction detecting light receiving elements 122. The detector 141 includes an amplifier 143 and a wave detector 144. The plurality of detectors 141 may include a band path filter (BPF) relevant to a frequency band to be received. The BPF cuts a signal derived from ambient light such as sunlight. The detector 141 may include a plurality of wave detectors relevant to a plurality of frequency bands.

The amplifier 143 is connected to the direction detecting light receiving element 122. An electric signal derived from the signal light received by the direction detecting light receiving element 122 is input to the amplifier 143. The amplifier 143 amplifies the input electric signal with a set amplification factor. For example, by operating the amplifier 143 in alternating current (AC) operation, the influence of sunlight can be removed. The amplification factor of the amplifier 143 can be arbitrarily set. The electric signal amplified by the amplifier 143 is output to the wave detector 144.

The signal of the modulation frequency to be received amplified by the amplifier 143 is input to the wave detector 144. The wave detector 144 detects the input signal. An amplifier may be disposed at a subsequent stage of the wave detector 144. The signal detected by the wave detector 144 is supplied to the ADC 146.

A signal detected by each of the plurality of wave detectors 144 is input to the ADC 146. The ADC 146 converts the input signal (analog signal) into a digital signal. The converted digital signal is output to the direction detection unit 147.

A signal derived from each of the plurality of direction detecting light receiving elements 122 is input to the direction detection unit 147. The direction detection unit 147 detects the arrival direction of the spatial optical signal according to the light receiving situation of the optical signal by each of the plurality of direction detecting light receiving elements 122.

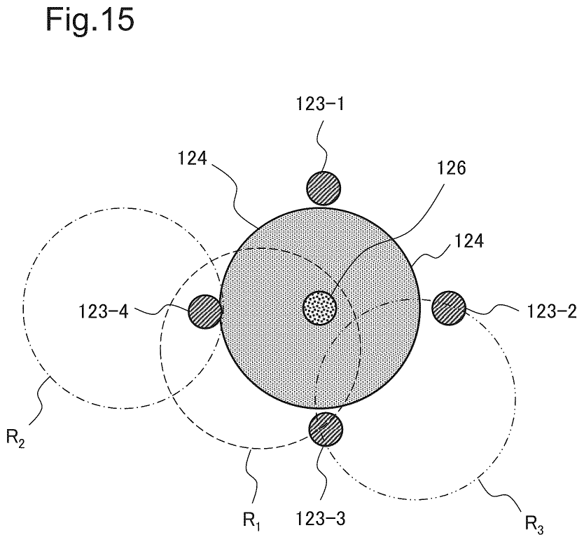

FIG. 15 is a conceptual diagram for explaining detection of the arrival direction of the spatial optical signal by the direction detection unit 147. FIG. 15 is a conceptual diagram of the light receiving surface of the light receiver 12 as viewed from the ball lens 11. FIG. 15 illustrates a positional relationship between the light receiving part 123 of the direction detecting light receiving element 122 and the light receiving part 126 of the communication light receiving element 125. In FIG. 15, numbers (1 to 4) are added to the end of the reference numerals representing the light receiving parts 123 of the plurality of direction detecting light receiving elements 122 to distinguish each other. FIG. 15 illustrates the inside of the light guide tube 124. The plurality of light receiving parts 123-1 to 123-4 are disposed on the circumference of a circle centered on the light receiving part 126 of the communication light receiving element 125. In FIG. 15, an example of a condensing range of light condensed by the ball lens 11 is indicated by a circle.

The signal light emitted within the condensing range R₁ (broken line) is received by the light receiving part 123-3 and the light receiving part 123-4. The direction detection unit 147 sets the moving direction of the transceiver 10 according to the light receiving situation of the signal light by the light receiving part 123-3 and the light receiving part 123-4. In a case where the signal light is emitted within the range of the condensing range R₁ (broken line), the direction detection unit 147 outputs a control signal for moving the position of the light receiver 12 to the lower left to the drive unit 131. The direction detection unit 147 may set the movement amount of the transceiver 10 according to the intensity of the signal light received by the light receiving part 123-3 and the light receiving part 123-4. The signal light emitted within the range of the condensing range R₁ (broken line) is received by the light receiving part 126 of the communication light receiving element 125. The direction detection unit 147 may set the moving direction and the moving amount of the light receiver 12 including the light receiving situation of the signal light by the light receiving part 126.

The signal light emitted within the condensing range R₂ (one-dot chain line) is received by the light receiving part 123-4. The direction detection unit 147 sets the moving direction of the transceiver 10 according to the light receiving situation of the signal light by the light receiving part 123-4. In a case where the signal light is emitted within the range of the condensing range R₂ (one-dot chain line), the direction detection unit 147 outputs a control signal for moving the position of the light receiver 12 to the right side to the drive unit 131. The direction detection unit 147 may set the movement amount of the transceiver 10 according to the intensity of the signal light received by the light receiving part 123-4.

The signal light emitted within the condensing range R₃ (two-dot chain line) is received by the light receiving part 123-2 and the light receiving part 123-3. The direction detection unit 147 sets the moving direction of the transceiver 10 according to the light receiving situation of the signal light by the light receiving part 123-2 and the light receiving part 123-3. In a case where the signal light is emitted within the range of the condensing range R₃ (two-dot chain line), the direction detection unit 147 outputs a control signal for moving the position of the light receiver 12 to the lower right to the drive unit 131. The direction detection unit 147 may set the movement amount of the transceiver 10 according to the intensity of the signal light received by the light receiving part 123-2 and the light receiving part 123-3.

The direction detection unit 147 outputs the moving direction of the transceiver 10 to the transmission control unit 132. Information including the moving direction of the transceiver 10 is notified to the communication target using a spatial optical signal.

The drive unit 131 acquires a control signal for setting the moving direction and the moving amount of the light receiver 12 from the direction detection unit 147. The drive unit 131 drives the vertical rotation mechanism 161 and the horizontal rotation mechanism 162 included in the rotation mechanism 16 in accordance with the acquired control signal. The drive unit 131 drives the drive devices included in the vertical rotation mechanism 161 and the horizontal rotation mechanism 162 to move the transceiver 10 in the vertical plane and the horizontal plane.

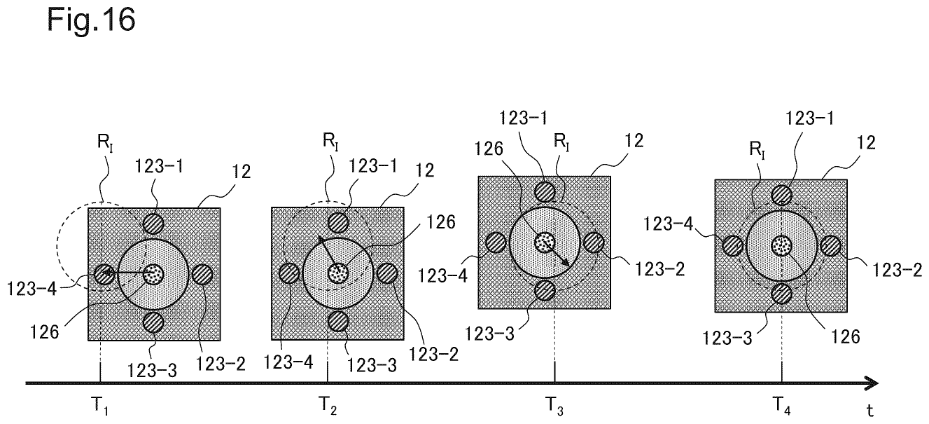

FIG. 16 is a conceptual diagram illustrating an example in which the position of the light receiver 12 is changed according to the intensity of the signal light received by the light receiving parts 123-1 to 123-4 included in the plurality of direction detecting light receiving elements 122. FIG. 16 illustrates a change in the relative position of the light receiver 12 with respect to the condensing range R₁ of the signal light condensed by the ball lens in time series. Hereinafter, an example in which the position of the light receiver 12 is adjusted based on the positional relationship on the paper surface will be described.

At timing T₁, the signal light is received by the light receiving part 123-4. In this state, if the position of the transceiver 10 is moved to the left side, the light receiving part 126 of the communication light receiving element 125 approaches the center of the condensing range R₁. The direction detection unit 147 outputs a control signal for moving the position of the transceiver 10 to the left side to the drive unit 131. The drive unit 131 drives the vertical rotation mechanism 161 and the horizontal rotation mechanism 162 included in the rotation mechanism 16 so as to move the position of the transceiver 10 to the left side according to the control signal.

At timing T₂, signal light is received by the light receiving part 123-1 and the light receiving part 123-4 according to a change in the position of the transceiver 10. At timing T₂, the signal light is received by the light receiving part 126 of the communication light receiving element 125. In this state, if the position of the transceiver 10 is moved obliquely upward to the left side, the light receiving part 126 of the communication light receiving element 125 approaches the center of the condensing range R₁. The direction detection unit 147 outputs a control signal for moving the position of the transceiver 10 obliquely upward to the left side to the drive unit 131. The drive unit 131 drives the vertical rotation mechanism 161 and the horizontal rotation mechanism 162 included in the rotation mechanism 16 so as to move the position of the transceiver 10 obliquely upward to the left side according to the control signal.

At timing T₃, the signal light is received by the light receiving part 123-2 and the light receiving part 123-3 according to the change in the position of the transceiver 10. At timing T₃, the signal light is received by the light receiving part 126 of the communication light receiving element 125. In this state, if the position of the transceiver 10 is moved obliquely downward to the right side, the light receiving part 126 of the communication light receiving element 125 approaches the center of the condensing range R₁. The direction detection unit 147 outputs a control signal for moving the position of the transceiver 10 obliquely downward to the right side to the drive unit 131. At this time, the direction detection unit 147 sets the moving distance of the light receiver 12 to be shorter than the transition from the timing T₂ to the timing T₃. The drive unit 131 drives the vertical rotation mechanism 161 and the horizontal rotation mechanism 162 included in the rotation mechanism 16 so as to move the position of the transceiver 10 obliquely downward to the right left side according to the control signal.

At timing T₄, the signal light is received by all the light receiving parts 123-1 to 123-4 and the light receiving part 126 of the communication light receiving element 125 according to the change in the position of the transceiver 10. This state is a state in which the light receiving part 126 of the communication light receiving element 125 substantially coincides with the center of the condensing range R₁. With this state, the optical signal derived from the spatial optical signal transmitted from the communication target can be efficiently received by the communication light receiving element 125.

The reception circuit 133 acquires an electric signal derived from the optical signal received by the light receiving part 126 of the communication light receiving element 125. The reception circuit 133 amplifies the acquired electric signal. The reception circuit 133 converts the amplified electric signal from an analog signal to a digital signal. The reception circuit 133 outputs the converted digital signal to the communication unit 135. For example, the reception circuit 133 may be provided with a limiting amplifier (not illustrated) at the preceding stage of an amplifier (not illustrated). If the limiting amplifier is provided, a dynamic range can be secured. For example, the reception circuit 133 may be provided with a high-pass filter or a band-pass filter (not illustrated). The high pass filter and the band pass filter cut off a signal derived from ambient light such as sunlight among the acquired signals, and selectively passes a signal of a high frequency component relevant to a wavelength band of the spatial optical signal.

The communication unit 135 decodes the signal output from the reception circuit 133. The communication unit 135 causes the transmission control unit 132 to transmit the spatial optical signal according to the decoded signal.

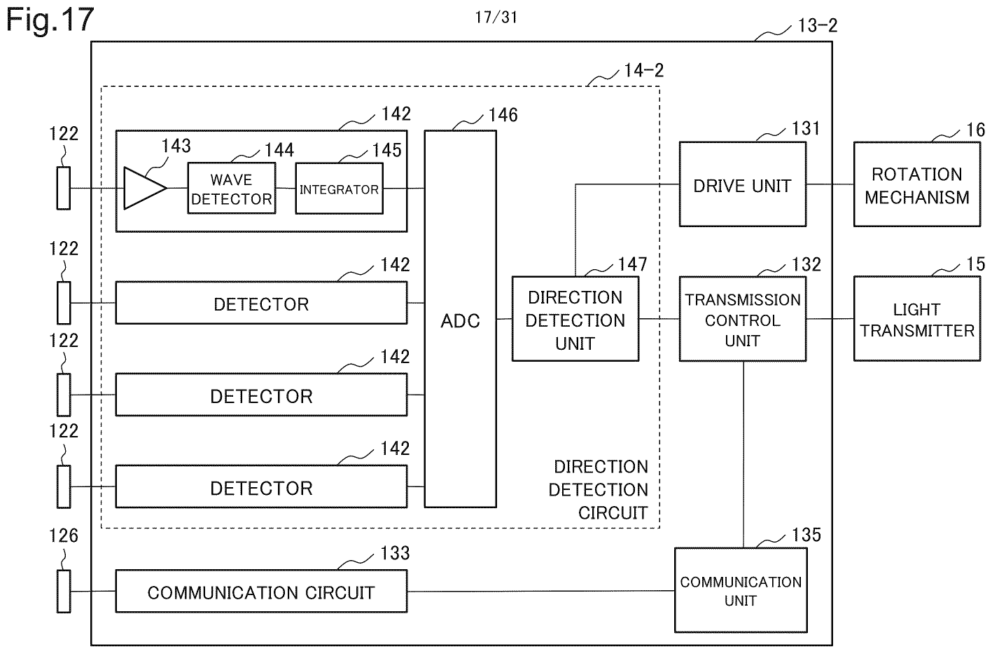

FIG. 17 is a conceptual diagram illustrating an example (communication control unit 13-2) of the configuration of the communication control unit 13. The communication control unit 13 includes a direction detection circuit 14-2, a drive unit 131, a transmission control unit 132, a reception circuit 133, and a communication unit 135. The communication control unit 13-2 (FIG. 17) differs from the communication control unit 13-1 (FIG. 14) in the configuration of a detector 142 included in the direction detection circuit 14-2.

The detector 142 includes an integrator 145 in addition to the amplifier 143 and the wave detector 144. The integrator 145 increases the intensity of the signal by integrating the signal that has passed through the amplifier 143 and the wave detector 144. A photodiode capable of high-speed operation has a small light receiving area and a small light reception intensity of an optical signal. According to the configuration of the communication control unit 13-2 (FIG. 17), since the intensity of the signal can be increased by the integrator 145, a photodiode capable of high-speed operation can be applied to the direction detecting light receiving element 122.

### [Rotation Mechanism]

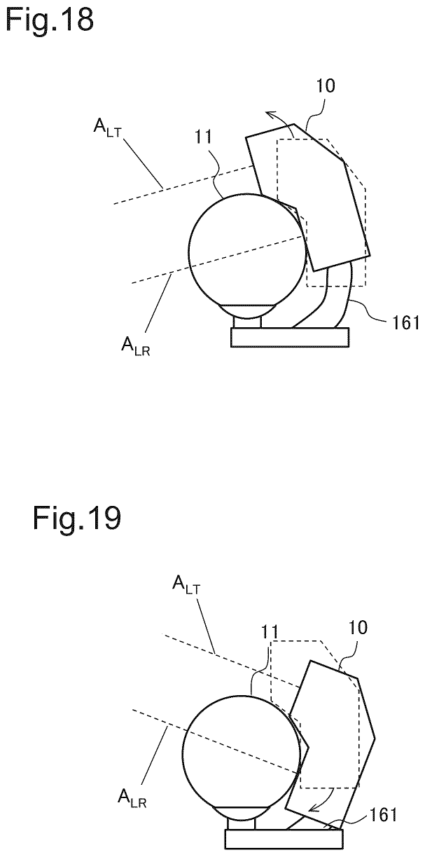

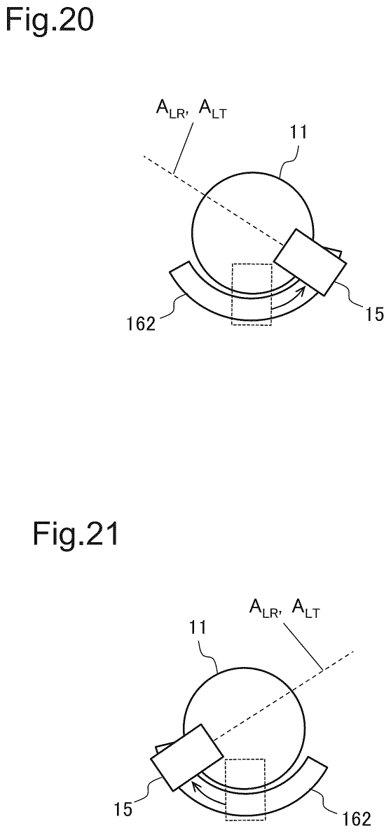

FIGS. 18 to 21 are conceptual diagrams for explaining an example of the movement of the rotation mechanism 16. FIGS. 18 and 19 relate to the operation of the vertical rotation mechanism 161. FIGS. 18 and 19 are diagrams of the vertical rotation mechanism 161 as viewed from a side. FIGS. 20 and 21 relate to the operation of the horizontal rotation mechanism 162. FIGS. 20 and 21 are diagrams of the vertical rotation mechanism 161 as viewed from above.

FIG. 18 illustrates an example in which the light reception axis A_{LR} and the light transmission axis A_{LT} of the spatial optical signal are directed downward in the vertical plane. Under the control of the communication control unit 13, the vertical rotation mechanism 161 moves the transceiver 10 counterclockwise in a vertical plane (paper plane) along a circular orbit having the center of the ball lens 11 as a rotation axis. The vertical rotation mechanism 161 moves the transceiver 10 in a vertical plane such that the light reception axis A_{LR} of the light receiver 12 of the transceiver 10 always passes through the center of the ball lens 11. If the light reception axis A_{LR} of the light receiver 12 is aligned in the direction of the communication target, the light transmission axis A_{LT} of the light transmitter 15 is aligned in the direction of the communication target. As a result, in the vertical plane, the light reception axis A_{LR} and the light transmission axis A_{LT} of the spatial optical signal are directed to the communication target located obliquely downward.

FIG. 19 illustrates an example in which the light reception axis A_{LR} and the light transmission axis A_{LT} of the spatial optical signal are directed upward in the vertical plane. Under the control of the communication control unit 13, the vertical rotation mechanism 161 moves the transceiver 10 clockwise along a circular orbit in a vertical plane (paper plane) with the center of the ball lens 11 as a rotation axis. The vertical rotation mechanism 161 moves the transceiver 10 in a vertical plane such that the light reception axis A_{LR} of the light receiver 12 of the transceiver 10 always passes through the center of the ball lens 11. If the light reception axis A_{LR} of the light receiver 12 is aligned in the direction of the communication target, the light transmission axis A_{LT} of the light transmitter 15 is aligned in the direction of the communication target. As a result, in the vertical plane, the light reception axis A_{LR} and the light transmission axis A_{LT} of the spatial optical signal are directed to the communication target located obliquely upward.

FIG. 20 illustrates an example in which the light reception axis A_{LR} and the light transmission axis A_{LT} of the spatial optical signal are directed to the left side in the horizontal plane. In plan view, the light reception axis A_{LR} and the light transmission axis A_{LT} overlap with each other. Under the control of the communication control unit 13, the horizontal rotation mechanism 162 moves the transceiver 10 counterclockwise along a circular orbit in a horizontal plane (paper plane) with the center of the ball lens 11 as a rotation axis. The horizontal rotation mechanism 162 moves the transceiver 10 in the horizontal plane such that the light reception axis A_{LR} of the light receiver 12 of the transceiver 10 always passes through the center of the ball lens 11. If the light reception axis A_{LR} of the light receiver 12 is aligned in the direction of the communication target, the light transmission axis A_{LT} of the light transmitter 15 is aligned in the direction of the communication target. As a result, in the horizontal plane, the light reception axis A_{LR} and the light transmission axis A_{LT} of the spatial optical signal are directed to the communication target located obliquely to the left side.

FIG. 21 illustrates an example in which the light reception axis A_{LR} and the light transmission axis A_{LT} of the spatial optical signal are directed to the right side in the horizontal plane. In plan view, the light reception axis A_{LR} and the light transmission axis A_{LT} overlap with each other. Under the control of the communication control unit 13, the horizontal rotation mechanism 162 moves the transceiver 10 clockwise along a circular orbit in a horizontal plane (paper plane) with the center of the ball lens 11 as a rotation axis. The horizontal rotation mechanism 162 moves the transceiver 10 in the horizontal plane such that the light reception axis A_{LR} of the light receiver 12 of the transceiver 10 always passes through the center of the ball lens 11. If the light reception axis A_{LR} of the light receiver 12 is aligned in the direction of the communication target, the light transmission axis A_{LT} of the light transmitter 15 is aligned in the direction of the communication target. As a result, in the horizontal plane, the light reception axis A_{LR} and the light transmission axis A_{LT} of the spatial optical signal are directed to the communication target located obliquely to the right side.

As illustrated in FIGS. 18 to 21, by aligning the transceiver 10 in the vertical plane and the horizontal plane, the light reception axis A_{LR} and the light transmission axis A_{LT} of the spatial optical signal are adjusted in the direction of the communication target. If the light reception axis A_{LR} and the light transmission axis A_{LT} of the spatial optical signal are adjusted in the direction of the communication target, spatial optical communication using the spatial optical signal can be established with the communication target.

### Modifications

Next, modifications of the present example embodiment will be described with reference to the drawings. Hereinafter, two modifications will be described. The following modifications are merely examples and do not limit the configurations of the modifications of the present example embodiment.

### First Modification

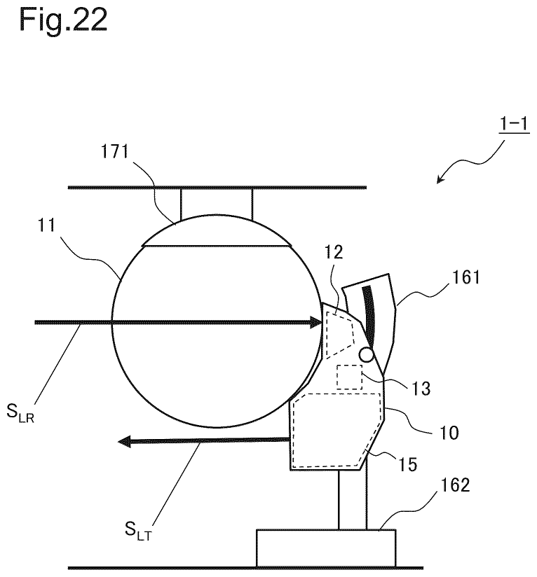

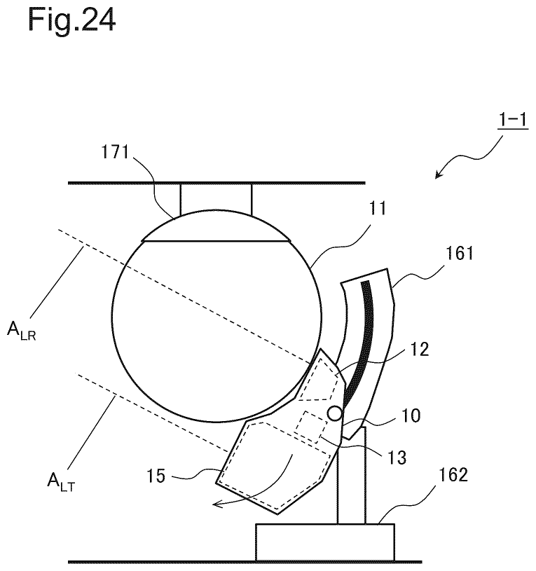

FIGS. 22 to 24 are conceptual diagrams for explaining a communication device 1-1 in the present disclosure. The communication device 1-1 of a first modification has a configuration in which the ball lens 11 is suspended from a top plate. FIGS. 22 to 24 are diagrams of the communication device 1-1 as viewed from a side. In FIGS. 22 to 24, movement of the transceiver 10 in a vertical plane will be described. The transceiver 10 is disposed upside down. Therefore, the light receiver 12 is located above the paper surface, and the light transmitter 15 is located below the paper surface. In FIGS. 22 to 24, description of the movement of the transceiver 10 in the horizontal plane is omitted. In FIGS. 22 to 24, description of the internal configuration of the transceiver 10 is omitted.

FIG. 22 illustrates an example in which the communication target is located on the left side. The spatial optical signal S_{LR} transmitted from the communication target is condensed by the ball lens 11 and received by the light receiver 12 of the transceiver 10. The spatial optical signal S_{LT} transmitted from the light transmitter 15 of the transceiver 10 is transmitted toward the communication target. A light transmission axis of the spatial optical signal S_{LR} and a light reception axis of the spatial optical signal S_{LT} are parallel to each other.

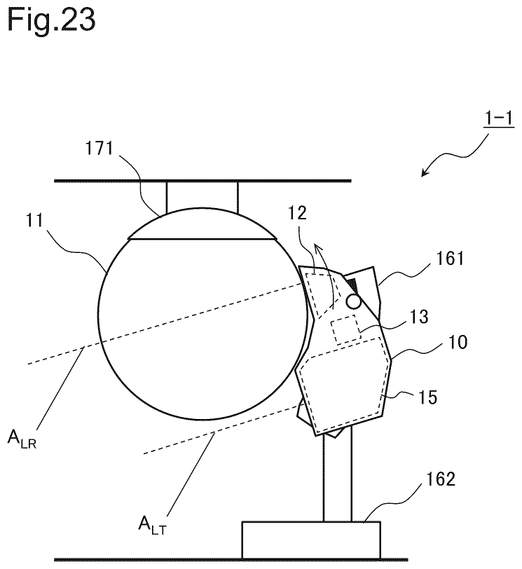

FIG. 23 illustrates an example in which the light reception axis A_{LR} and the light transmission axis A_{LT} of the spatial optical signal are directed downward in the vertical plane. Under the control of the communication control unit 13, the vertical rotation mechanism 161 moves the transceiver 10 counterclockwise in a vertical plane (paper plane) along a circular orbit having the center of the ball lens 11 as a rotation axis. The vertical rotation mechanism 161 moves the transceiver 10 in a vertical plane such that the light reception axis A_{LR} of the light receiver 12 of the transceiver 10 always passes through the center of the ball lens 11. If the light reception axis A_{LR} of the light receiver 12 is aligned in the direction of the communication target, the light transmission axis A_{LT} of the light transmitter 15 is aligned in the direction of the communication target. As a result, in the vertical plane, the light reception axis A_{LR} and the light transmission axis A_{LT} of the spatial optical signal are directed to the communication target located obliquely downward.

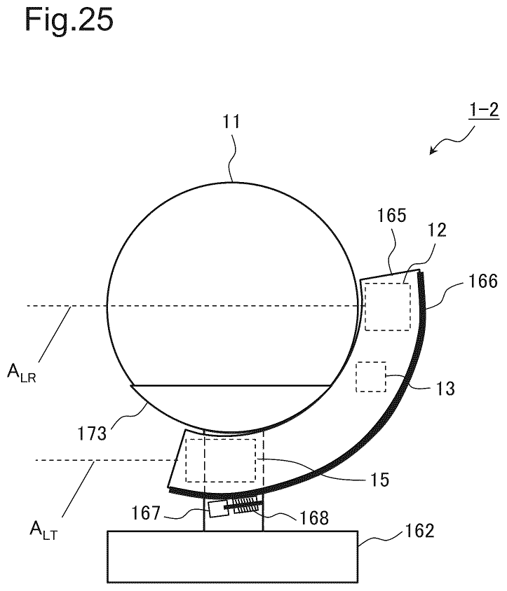

FIG. 25 illustrates an example in which the light reception axis A_{LR} and the light transmission axis A_{LT} of the spatial optical signal are directed upward in the vertical plane. Under the control of the communication control unit 13, the vertical rotation mechanism 161 moves the transceiver 10 clockwise along a circular orbit in a vertical plane (paper plane) with the center of the ball lens 11 as a rotation axis. The vertical rotation mechanism 161 moves the transceiver 10 in a vertical plane such that the light reception axis A_{LR} of the light receiver 12 of the transceiver 10 always passes through the center of the ball lens 11. If the light reception axis A_{LR} of the light receiver 12 is aligned in the direction of the communication target, the light transmission axis A_{LT} of the light transmitter 15 is aligned in the direction of the communication target. As a result, in the vertical plane, the light reception axis A_{LR} and the light transmission axis A_{LT} of the spatial optical signal are directed to the communication target located obliquely upward.

### Second Modification

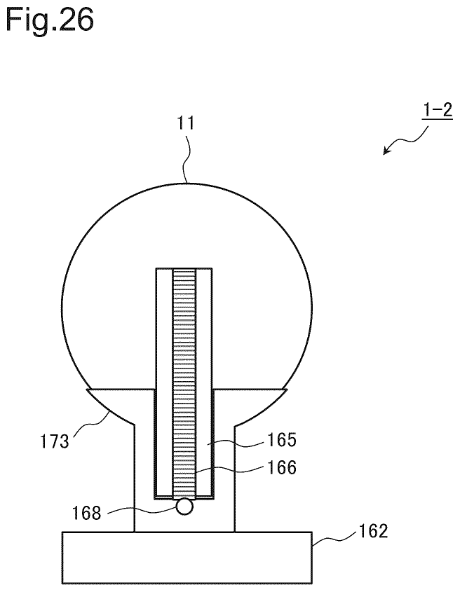

FIGS. 25 to 27 are conceptual diagrams for explaining a communication device 1-2 in the present disclosure. The communication device 1-2 of the second modification has a configuration in which the transceiver 10 and the ball lens 11 are integrated.

FIG. 25 are diagrams of the communication device 1-2 as viewed from a side. FIG. 25 are diagrams of the communication device 1-2 as viewed from a back surface. The communication device 1-2 includes a ball lens 11, a vertical rotation mechanism 165, a worm wheel 166, a motor 167, and a cylindrical worm 168. The ball lens 11 and the vertical rotation mechanism 165 are integrated. The ball lens 11 and the vertical rotation mechanism 165 are rotatably supported by a support unit 173. The worm wheel 166 is formed along the outer peripheral surface of the vertical rotation mechanism 165. The gear of the worm wheel 166 and the gear of the cylindrical worm 168 are meshed with each other. The cylindrical worm 168 rotates in accordance with the drive of the motor 167 under the control of the communication control unit 13. The worm wheel 166 rotates on the support unit 173 in accordance with the rotation of the cylindrical worm 168.

The vertical rotation mechanism 165 includes a transmission/reception function similar to that of the transceiver 10 (FIG. 1). Similarly to the transceiver 10 (FIG. 1), the transmission/reception function of the vertical rotation mechanism 165 includes a light receiver 12, a communication control unit 13, and a light transmitter 15. In FIG. 25, an example of a region where the light receiver 12, the communication control unit 13, and the light transmitter 15 are disposed is indicated by a broken line. In FIG. 25, regions (broken lines) in which the light receiver 12, the communication control unit 13, and the light transmitter 15 are disposed schematically represent the positions thereof, and do not represent accurate positions.

In the housing of the vertical rotation mechanism 165, windows are formed in front of the light receiving surface of the light receiver 12 (left side in the drawing) and in front of the transmission surface of the light transmitter 15 (left side in the drawing). For example, a window material formed of a material through which a spatial optical signal is transmitted is disposed in the window. For example, the window may be open. In the state of FIG. 25, the reception surface of the light receiver 12 is directed to the left side. In the state of FIG. 25, the transmission surface of the light transmitter 15 is directed to the left side. A light transmission axis A_{LT} of the spatial optical signal transmitted from the light transmitter 15 passes below the ball lens 11. A light transmission axis A_{LT} of the spatial optical signal transmitted from the light transmitter 15 is parallel to the light reception axis A_{LR} of the communication light receiving element of the light receiver 12. The light transmission axis A_{LT} and the light reception axis A_{LR} are always in a parallel relationship. Therefore, by controlling the rotation mechanism 16 so as to direct the light receiving surface of the light receiver 12 toward the communication target, the transmission direction of the spatial optical signal can be directed toward the communication target.

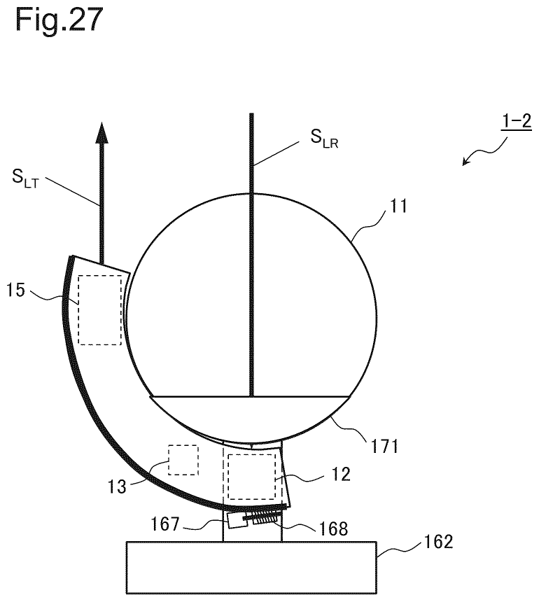

FIG. 27 illustrates an example in which the light reception axis A_{LR} and the light transmission axis A_{LT} of the spatial optical signal are directed directly upward in the vertical plane. Under the control of the communication control unit 13, the vertical rotation mechanism 165 rotates in a vertical plane (paper surface) together with the ball lens 11. The communication control unit 13 rotates the vertical rotation mechanism 165 in a vertical plane so that the light reception axis A_{LR} of the light receiver 12 of the vertical rotation mechanism 165 always passes through the center of the ball lens 11. The reception direction of the spatial optical signal S_{LR} received by the light receiver 12 and the transmission direction of the spatial optical signal S_{LT} transmitted from the light transmitter 15 are parallel to each other. Unless the motor 167 is driven, the reception direction of the spatial optical signal S_{LR} and the transmission direction of the spatial optical signal S_{LT} transmitted from the light transmitter 15 do not change. According to the configuration of the communication device 1-2, 180 degrees above the vertical rotation mechanism 165 can be covered. Therefore, the communication device 1-2 is suitable for spatial optical communication with a flying object such as a drone. The communication device 1-2 is suitable for spatial optical communication with an artificial satellite located in the sky.

### [Communication Device]

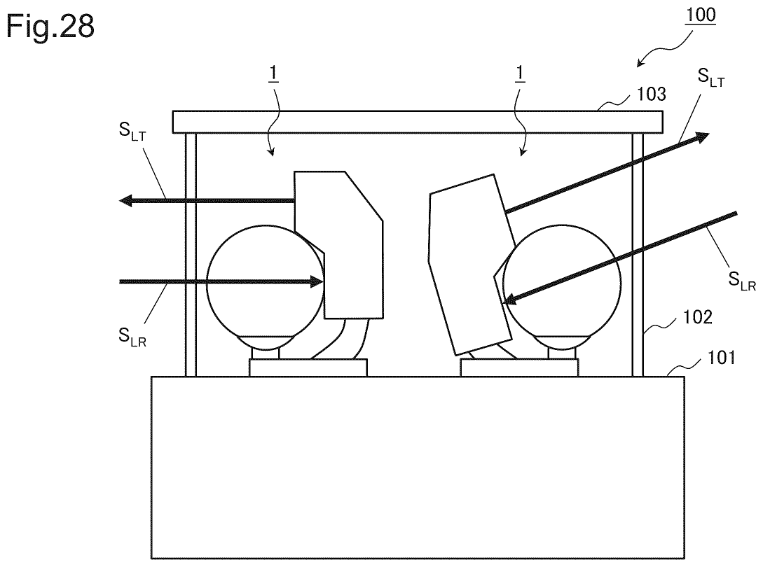

FIG. 28 is a conceptual diagram illustrating an example of a configuration of a communication device 100 including a plurality of communication devices 1. The communication device 100 includes a plurality of communication devices 1, a base 101, a window 102, and a top plate 103. The plurality of communication devices 1 are disposed on the upper surface of the base 101. In other words, the communication device 100 includes a plurality of transceivers disposed on concentric circles in a horizontal plane. The window 102 that covers the sides of the plurality of communication devices 1 is disposed on the upper surface of the base 101. A communication control unit (not illustrated) that controls the plurality of communication devices 1 is stored inside the base 101. The communication control unit has a function similar to that of the communication control unit 13. The window 102 is made of a material through which light in the wavelength band of the spatial optical signal is transmitted. For example, the window 102 may be provided with an optical filter that cuts light that is not in the wavelength band of the spatial optical signal. The top plate 103 is placed above the window 102.

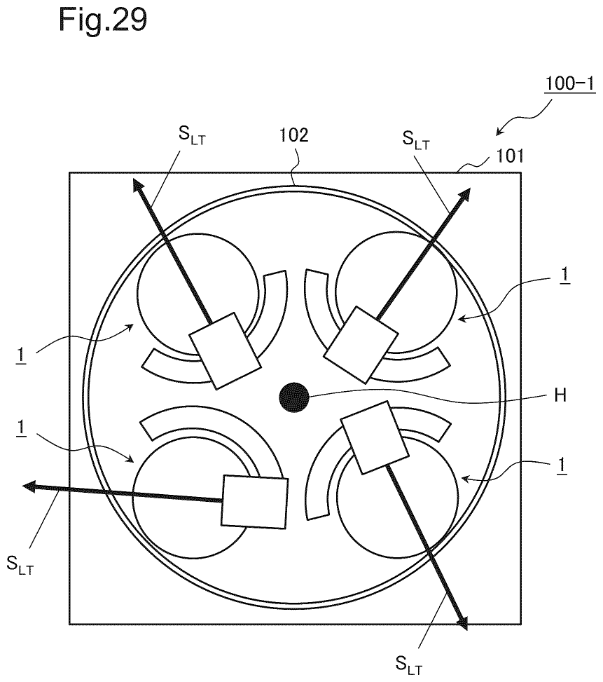

FIG. 29 is a plan view of a communication device 100-1 including four communication devices 1 as viewed from above. The communication device 1 has a configuration similar to that of the communication device 1 (FIGS. 1 to 21). The communication device 1 may include a transceiver according to the modification. The four communication devices 1 are disposed in a circular shape around a wiring hole H. The four communication devices 1 move independently of each other under the control of the communication control device. The four communication devices 1 transmit the spatial optical signals S_{LT} independently of each other under the control of the communication control device. If each communication device 1 can cover a transmission/reception direction of 90 degrees in a horizontal plane, spatial optical communication using a spatial optical signal can be achieved with an arbitrary communication target located in an azimuth of 360 degrees in the horizontal plane.

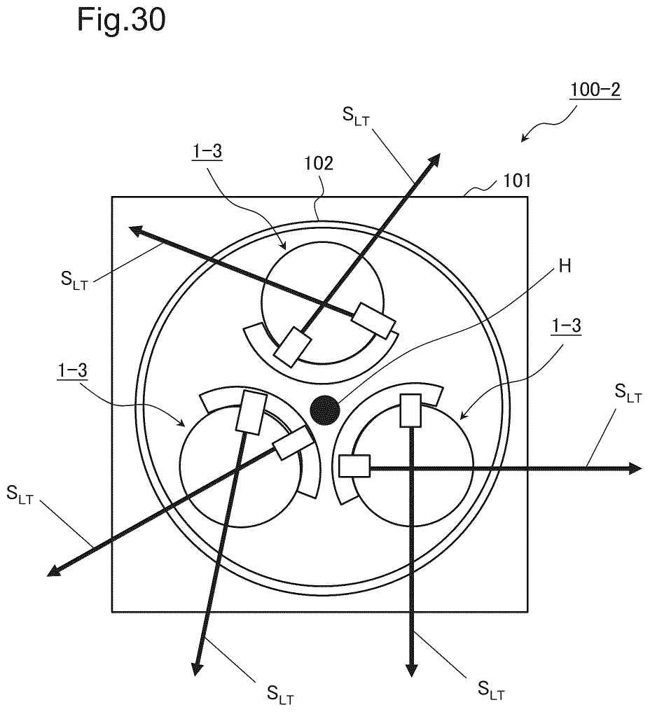

FIG. 30 is a plan view of a communication device 100-2 including three communication devices 1-3 as viewed from above. The communication device 1-3 is different from the communication device 1 (FIGS. 1 to 21) in including two transceivers 10. The communication device 1-3 may include a transceiver of the modification. The three communication devices 1-3 are disposed in a circular shape around the wiring hole H. The three communication devices 1-3 each move independently under the control of the communication control device. The four communication devices 1-3 each independently transmit the spatial optical signal S_{LT} under the control of the communication control device. If each communication device 1-3 can cover a transmission/reception direction of 120 degrees in a horizontal plane, spatial optical communication using a spatial optical signal can be achieved with an arbitrary communication target located in an azimuth of 360 degrees in the horizontal plane.

### Application Example

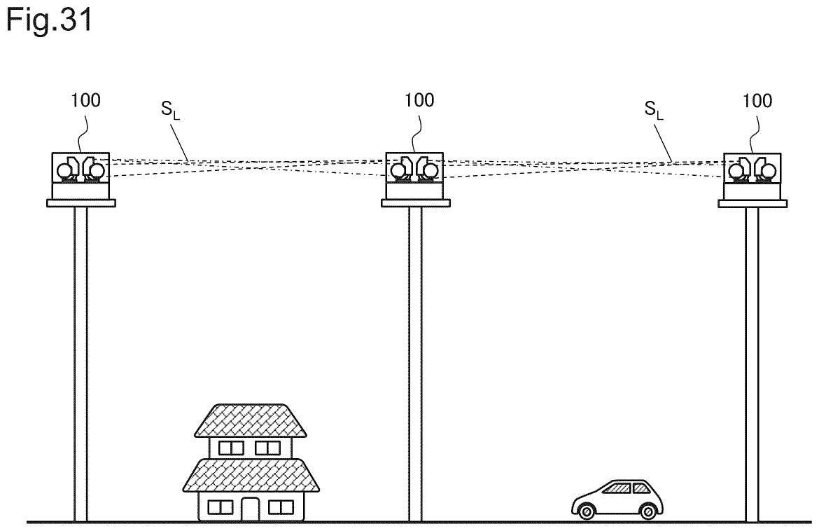

Next, an application example of the present example embodiment will be described with reference to the drawings. In the following application example, an example in which a plurality of communication devices 100 transmit and receive the spatial optical signal S_{L} will be described. FIG. 31 is a conceptual diagram for explaining the present application. In the present application example, an example (communication system) of a communication network which is configured by a plurality of communication devices 100 on an upper portion (space above a pole) of a pole such as a utility pole or a street lamp disposed in a town will be described.

There are few obstacles in the space above the pole. Therefore, the space above the pillar is suitable for installing the communication device 100. If the communication device 100 is installed at the same height, the arrival direction of the spatial optical signal S_{L} is limited to the horizontal direction. The pair of communication devices 100 transmitting and receiving the spatial optical signal S_{L} is disposed at a position where at least one communication device 100 receives the spatial optical signal S_{L} transmitted from the other communication device 100. The pair of communication devices 100 may be disposed to transmit and receive spatial optical signals to and from each other. In a case where a communication network of spatial optical signals S_{L} is configured by a plurality of communication devices 100, the communication device 100 positioned in the middle may be configured to relay a spatial optical signal S_{L} transmitted from another communication device 100 to another communication device 100.

According to the present application example, it is possible to perform communication using a spatial optical signal among the plurality of communication devices 100 disposed in the space above the pole. For example, in accordance with the communication among the communication devices 100, communication by radio communication may be performed between the communication device 100 and a radio device or a base station installed in an automobile, a house, or the like. For example, the communication device 100 may be connected to the Internet via a communication cable or the like installed on a pole.

As described above, the communication device according to the present example embodiment includes the ball lens, the transceiver, and the rotation mechanism. The ball lens is a spherical lens. The transceiver includes a light receiver, a light transmitter, and a communication control unit. The transceiver has a configuration in which a light receiver and a light transmitter are integrated. The light receiver has a light reception axis passing through the center of the ball lens. The light transmitter has a light transmission axis parallel to the light reception axis. The communication control unit detects the arrival direction of the spatial optical signal according to the light receiving position of the optical signal by the light receiver. The communication control unit controls the rotation mechanism according to the detected arrival direction of the spatial optical signal to move the transceiver. The communication control unit causes the light transmitter to transmit a spatial optical signal toward the communication target. The rotation mechanism rotatably supports the transceiver along a circular orbit in a horizontal plane and a vertical plane centered on the ball lens. The rotation mechanism includes a horizontal rotation mechanism and a vertical rotation mechanism. The horizontal rotation mechanism moves the transceiver along a circular orbit in a horizontal plane centered on the ball lens. The vertical rotation mechanism moves the transceiver along a circular orbit in a vertical plane centered on the ball lens.

In the communication device of the present example embodiment, the light reception axis and the light transmission axis of the transceiver are parallel. In the communication device of the present example embodiment, the light receiver and the light transmitter are rotatable about the ball lens in a horizontal plane and a vertical plane in an integrated state. In the communication device of the present example embodiment, the light reception axis and the light transmission axis of the transceiver are always parallel even if the transceiver is moved. Therefore, according to the present example embodiment, spatial optical communication using a spatial optical signal can be established with a communication target disposed in an arbitrary azimuth.

In one aspect of the present example embodiment, the light receiver includes a substrate, a plurality of direction detecting light receiving elements, a light guide tube, a communication light receiving element, and a wavelength filter. The substrate has a light receiving surface facing the ball lens and a back surface facing the light receiving surface. A through hole penetrating the light receiving surface and the back surface is opened in the substrate. The plurality of direction detecting light receiving elements are disposed around the through hole on the light receiving surface of the substrate with the light receiving part facing the ball lens. The light guide tube includes a light-receiving-surface-side opening end associated with the through hole, and a back-surface-side opening end facing the light-receiving-surface-side opening end. The light guide tube is disposed on the back surface side of the substrate in accordance with the through hole. The communication light receiving element is disposed at the back-surface-side opening end of the light guide tube with the light receiving part facing the ball lens. The wavelength filter is disposed at a preceding stage of the light receiving parts of the plurality of direction detecting light receiving elements and the plurality of communication light receiving elements. The wavelength filter selectively passes light in a wavelength band of a spatial optical signal to be received. The light transmitter includes a light source, a collimator, and a spatial light modulator. The light source emits light. The collimator converts light emitted from the light source into parallel light. The spatial light modulator includes a modulation part that modulates parallel light into modulation light. According to the present aspect, the arrival direction of the spatial optical signal can be detected according to the optical signals received by the plurality of direction detecting light receiving elements. According to the present aspect, the transmission direction of the spatial optical signal can be finely adjusted by adjusting the pattern (phase image) set in the modulation part of the spatial light modulator.

In one aspect of the present example embodiment, the communication control unit detects the arrival direction of the spatial optical signal according to the light reception intensity of the optical signal by each of the plurality of direction detecting light receiving elements included in the light receiver. The communication control unit controls the rotation mechanism to move the transceiver to a position where light reception intensities of optical signals by the plurality of direction detecting light receiving elements are uniform. According to the present aspect, the transmission/reception direction of the transceiver can be adjusted according to the light reception intensity of the optical signal by each of the plurality of direction detecting light receiving elements.

In an aspect of the present example embodiment, the transceiver includes a worm wheel, a cylindrical worm, and a motor. The worm wheel is formed along an outer periphery of the transceiver in a vertical plane. The cylindrical worm meshes with the gear of the worm wheel. The motor rotates the cylindrical worm under the control of the communication control unit. The inner periphery of the transceiver is fixed along the outer periphery of the ball lens in the vertical plane. According to the present aspect, the ball lens and the transceiver can be integrally rotated by driving the motor.

In an aspect of the present example embodiment, a plurality of transceivers whose transmission and reception optical axes are directed in mutually different azimuths are disposed on concentric circles in a horizontal plane. For example, the plurality of transceivers are supported by different rotation mechanisms. For example, at least two transceivers are installed for one rotation mechanism. According to the present aspect, a communication device including a plurality of transceivers can be achieved. If the communication axes of the plurality of transceivers are directed in different azimuths, communication can be established with a plurality of communication devices located in a horizontal plane.

A communication system according to an aspect of the present example embodiment includes a plurality of the above-described communication devices. The plurality of communication devices are disposed so as to mutually transmit and receive spatial optical signals. According to the present aspect, it is possible to achieve a communication network that transmits and receives a spatial optical signal.

### Second Example Embodiment

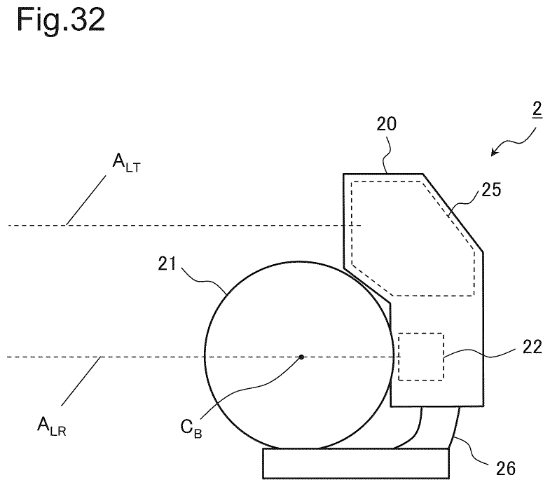

Next, a communication device according to a second example embodiment will be described with reference to the drawings. The communication device of the present example embodiment has a configuration in which the communication device of the first example embodiment is simplified. FIG. 32 is a conceptual diagram illustrating an example of a configuration of the communication device in the present disclosure; and FIG. 32 is a conceptual diagram of a communication device 2 as viewed from a side.

The communication device 2 includes a ball lens 21, a transceiver 20, and a rotation mechanism 26. The ball lens 21 is a spherical lens. The transceiver 20 has a configuration in which a light receiver 22 and a light transmitter 25 are integrated. The light receiver 22 has a light reception axis A_{LR} passing through the center of the ball lens 21. The light transmitter 25 has a light transmission axis A_{LT} parallel to the light reception axis A_{LR}. The rotation mechanism 26 rotatably supports the transceiver 20 along a circular orbit in a horizontal plane and a vertical plane centered on the ball lens 11.

In the communication device of the present example embodiment, the light reception axis and the light transmission axis of the transceiver are parallel. In the communication device of the present example embodiment, the light receiver and the light transmitter are rotatable about the ball lens in a horizontal plane and a vertical plane in an integrated state. In the communication device of the present example embodiment, the light reception axis and the light transmission axis of the transceiver are always parallel even if the transceiver is moved. Therefore, according to the present example embodiment, spatial optical communication using a spatial optical signal can be established with a communication target disposed in an arbitrary azimuth.

### (Hardware)

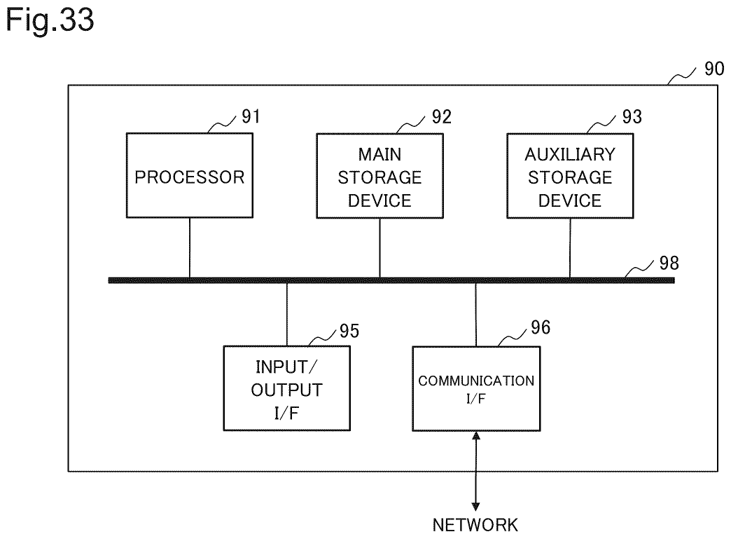

Next, a hardware configuration for executing control and processing in the present disclosure will be described with reference to the drawings. Here, an example of such a hardware configuration is an information processing device 90 (computer) in FIG. 33. The information processing device 90 in FIG. 33 is a configuration example for executing the control and processing in the present disclosure and does not limit the scope of the present disclosure.

As illustrated in FIG. 33, the information processing device 90 includes a processor 91, a main storage device 92, an auxiliary storage device 93, an input/output interface 95, and a communication interface 96. In FIG. 33, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing in the present disclosure. The processor 91 executes the program developed in the main storage device 92. The processor 91 executes the control and processing in the present disclosure by executing the program.

The main storage device 92 has a region in which a program is developed. A program stored in the auxiliary storage device 93 or the like is developed in the main storage device 92 by the processor 91. The main storage device 92 is implemented by, for example, a volatile memory such as a dynamic random-access memory (DRAM). A nonvolatile memory such as a magneto resistive random-access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing in the present disclosure. The hardware configuration of FIG. 33 is an example of a hardware configuration for executing the control and processing in the present disclosure and does not limit the scope of the present disclosure. A program for causing a computer to execute the control and processing in the present disclosure is also included in the scope of the present disclosure.

A program recording medium in which the program in the present example embodiment is also recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium.

The components in the present disclosure may be arbitrarily combined. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments may be described as the following Supplementary Notes, but are not limited to the following.

### Supplementary Note 1

A communication device including:
a ball lens;
a transceiver in which a light receiver having a light reception axis passing through a center of the ball lens and a light transmitter having a light transmission axis parallel to the light reception axis are integrated; and
a rotation mechanism that rotatably supports the transceiver along a circular orbit in a horizontal plane and a vertical plane centered on the ball lens.

### Supplementary Note 2

The communication device according to Supplementary Note 1, in which
the rotation mechanism includes:
a horizontal rotation mechanism that moves the transceiver along a circular orbit in the horizontal plane centered on the ball lens; and
a vertical rotation mechanism that moves the transceiver along a circular orbit in the vertical plane centered on the ball lens.

### Supplementary Note 3

The communication device according to Supplementary Note 2, in which
the light receiver includes:
a substrate having a light receiving surface directed to the ball lens and a back surface opposed to the light receiving surface, the substrate having a through hole penetrating the light receiving surface and the back surface;
a plurality of direction detecting light receiving elements disposed around the through hole on the light receiving surface of the substrate with a light receiving part facing the ball lens;
a light guide tube including a light-receiving-surface-side opening end associated with the through hole and a back-surface-side opening end opposed to the light-receiving-surface-side opening end, the light guide tube being disposed on a side of the back surface of the substrate in accordance with the through hole;
a communication light receiving element disposed at the back-surface-side opening end of the light guide tube with a light receiving part facing the ball lens; and
a wavelength filter disposed at a preceding stage of light receiving parts of the plurality of direction detecting light receiving elements and the communication light receiving element, the wavelength filter selectively passing light in a wavelength band of a spatial optical signal that is a reception target, and
the light transmitter includes:
a light source;
a collimator converting light emitted from the light source into parallel light; and
a spatial light modulator including a modulation part that modulates the parallel light into modulation light.

### Supplementary Note 4

The communication device according to Supplementary Note 3, including: a communication controller that detects an arrival direction of a spatial optical signal according to a light receiving position of an optical signal by the light receiver, controls the rotation mechanism according to an arrival direction of a detected spatial optical signal to move the transceiver, and causes the light transmitter to transmit a spatial optical signal toward a communication target.

### Supplementary Note 5

The communication device according to Supplementary Note 4, in which
the communication controller
detects an arrival direction of a spatial optical signal according to a light reception intensity of an optical signal by each of a plurality of the direction detecting light receiving elements included in the light receiver, and
controls the rotation mechanism to move the transceiver to a position where light reception intensities of optical signals by a plurality of the direction detecting light receiving elements are uniform.

### Supplementary Note 6

The communication device according to Supplementary Note 4, in which
the transceiver includes:
a worm wheel formed along an outer periphery of the transceiver in the vertical plane;
a cylindrical worm meshed with a gear of the worm wheel; and
a motor that rotates the cylindrical worm in accordance with control of the communication controller, and
an inner periphery of the transceiver is fixed along an outer periphery of the ball lens in the vertical plane.

### Supplementary Note 7

The communication device according to Supplementary Note 1, in which a plurality of the transceivers whose transmission and reception optical axes are directed in mutually different azimuths are disposed on concentric circles in a horizontal plane.

### Supplementary Note 8

The communication device according to Supplementary Note 7, in which a plurality of the transceivers are supported by the rotation mechanisms different from each other.

### Supplementary Note 9

The communication device according to Supplementary Note 7, in which at least two of the transceivers are installed for one of the rotation mechanisms.

### Supplementary Note 10

A communication system including:
a plurality of communication devices according to any one of Supplementary Notes 1 to 9, in which a plurality of the communication devices are disposed to transmit and receive spatial optical signals to and from each other.

1. A communication device comprising:
a ball lens;
a transceiver in which a light receiver having a light reception axis passing through a center of the ball lens and a light transmitter having a light transmission axis parallel to the light reception axis are integrated; and
a rotation mechanism that rotatably supports the transceiver along a circular orbit in a horizontal plane and a vertical plane centered on the ball lens.

2. The communication device according to claim 1, wherein
the rotation mechanism includes:
a horizontal rotation mechanism that moves the transceiver along a circular orbit in the horizontal plane centered on the ball lens; and
a vertical rotation mechanism that moves the transceiver along a circular orbit in the vertical plane centered on the ball lens.

3. The communication device according to claim 2, wherein
the light receiver includes:
a substrate having a light receiving surface directed to the ball lens and a back surface opposed to the light receiving surface, the substrate having a through hole penetrating the light receiving surface and the back surface;
a plurality of direction detecting light receiving elements disposed around the through hole on the light receiving surface of the substrate with a light receiving part facing the ball lens;
a light guide tube including a light-receiving-surface-side opening end associated with the through hole and a back-surface-side opening end opposed to the light-receiving-surface-side opening end, the light guide tube being disposed on a side of the back surface of the substrate in accordance with the through hole;
a communication light receiving element disposed at the back-surface-side opening end of the light guide tube with a light receiving part facing the ball lens; and
a wavelength filter disposed at a preceding stage of light receiving parts of the plurality of direction detecting light receiving elements and the communication light receiving element, the wavelength filter selectively passing light in a wavelength band of a spatial optical signal that is a reception target, and
the light transmitter includes:
a light source;
a collimator converting light emitted from the light source into parallel light; and
a spatial light modulator including a modulation part that modulates the parallel light into modulation light.

4. The communication device according to claim 3, further comprising:
a communication controller that includes
a memory storing instructions, and
a processor connected to the memory and configured to execute the instructions to
detect an arrival direction of a spatial optical signal according to a light receiving position of an optical signal by the light receiver,
control the rotation mechanism according to an arrival direction of a detected spatial optical signal to move the transceiver, and
cause the light transmitter to transmit a spatial optical signal toward a communication target.

5. The communication device according to claim 4, wherein
the processor of the communication controller is configured to execute the instructions to
detect an arrival direction of a spatial optical signal according to a light reception intensity of an optical signal by each of a plurality of the direction detecting light receiving elements included in the light receiver, and
control the rotation mechanism to move the transceiver to a position where light reception intensities of optical signals by a plurality of the direction detecting light receiving elements are uniform.

6. The communication device according to claim 4, wherein
the transceiver includes:
a worm wheel formed along an outer periphery of the transceiver in the vertical plane;
a cylindrical worm meshed with a gear of the worm wheel; and
a motor that rotates the cylindrical worm in accordance with control of the communication controller, and wherein
an inner periphery of the transceiver is fixed along an outer periphery of the ball lens in the vertical plane.

7. The communication device according to claim 1, wherein
a plurality of the transceivers whose transmission and reception optical axes are directed in mutually different azimuths are disposed on concentric circles in a horizontal plane.

8. The communication device according to claim 7, wherein
a plurality of the transceivers are supported by the rotation mechanisms different from each other.

9. The communication device according to claim 7, wherein at least two of the transceivers are installed for one of the rotation mechanisms.

10. A communication system comprising:
a plurality of communication devices according to claim 1, wherein
a plurality of the communication devices are disposed to transmit and receive spatial optical signals to and from each other.
